(19) United States
(12) Patent Application Publication
(10) Pub. No.: US 2024/0113399 A1
(43) Pub. Date: Apr. 4, 2024

(54) ELECTROCHEMICAL APPARATUS AND ELECTRICAL DEVICE

(71) Applicant: Xiamen Ampack Technology Limited, Xiamen (CN)

(72) Inventor: Liangzhen XIAO, Xiamen (CN)

(73) Assignee: Xiamen Ampack Technology Limited, Xiamen (CN)

(21) Appl. No.: 18/476,446

(22) Filed: Sep. 28, 2023

(30) Foreign Application Priority Data
Sep. 29, 2022 (CN) 202211204882.4

(51) Int. Cl. H01M 50/516; H01M 50/211; H01M 50/503

(52) U.S. Cl. CPC H01M 50/516; H01M 50/211; H01M 50/503

(57) ABSTRACT

An electrochemical apparatus includes a first battery cell, a second battery cell, and a first conductive member. The first battery cell includes a first conductive plate, the second battery cell includes a second conductive plate, and the first conductive plate and the second conductive plate are stacked on the first conductive member. A mutually connected portion of the first conductive plate and the second conductive plate includes a first region and a second region, the first conductive plate and the second conductive plate are welded to the first conductive member in the first region, the first conductive plate and the second conductive plate are connected in the second region through welding, and the second region is not connected to the first conductive member through welding.

### CROSS REFERENCE TO RELATED APPLICATIONS

This application claims priority from Chinese Patent Application No. 202211204882.4, filed on Sep. 29, 2022, the content of which is incorporated herein by reference in its entirety.

### TECHNICAL FIELD

This application relates to the technical field of energy storage, and in particular, to an electrochemical apparatus and an electrical device.

### BACKGROUND

When a battery module is assembled, a plurality of layers of conductive plates are welded on a conductive member. It is not only necessary to weld the plurality of layers of conductive plates, but also to weld the plurality of layers of conductive plates to the conductive member. At present, a commonly used welding means is one section-type welding, however, one-section welding is very prone to overwelding, burning through, or rosin joint, resulting in an unsatisfactory welding effect, and thus there is a risk of poor welding of the plurality of layers of conductive plates and the conductive member.

### SUMMARY

In view of the foregoing condition, it is necessary to provide an electrochemical apparatus, which can improve a welding effect of a plurality of layers of conductive plates and a conductive member, and reduce a risk of poor welding.

An embodiment of this application provides an electrochemical apparatus. The electrochemical apparatus includes a first battery cell, a second battery cell, and a first conductive member. The first battery cell includes a first conductive plate, the second battery cell and the first battery cell are stacked in a first direction, and the second battery cell includes a second conductive plate. The first conductive plate and the second conductive plate are stacked on the first conductive member, and the first conductive plate and the second conductive plate are connected to the first conductive member through welding. A mutually connected portion of the first conductive plate and the second conductive plate includes a first region and a second region, the first conductive plate and the second conductive plate are welded to the first conductive member in the first region, the first conductive plate and the second conductive plate are connected in the second region through welding, and the second region is not connected to the first conductive member through welding. In the foregoing electrochemical apparatus, the first conductive plate and the second conductive plate are welded to the first conductive member in the first region, and the first conductive plate and the second conductive plate are connected in the second region through welding, so that different welding parameters can be respectively applied to the first region and the second region, thereby improving a welding effect of the first region and a welding effect of the second region, and reducing a risk of poor welding.

In some embodiments of this application, a length of the first region in a second direction is greater than a length of the first region in the first direction; a length of the second region in the second direction is greater than a length of the second region in the first direction; and the second direction is perpendicular to the first direction. By providing the foregoing first region and second region, an area percentage of the first region and an area percentage of the second region can be increased, thereby improving a welding effect.

In some embodiments of this application, in a second direction perpendicular to the first direction, a length of the first region is a first length, a length of the second region is a second length, and the first length is not equal to the second length.

In some embodiments of this application, the first length is less than the second length.

In some embodiments of this application, the first length is greater than the second length.

In some embodiments of this application, in a third direction perpendicular to the first direction, a projection of the first region at least partially overlaps a projection of the first conductive member, and a projection of the second region is separated from the projection of the first conductive member. As mentioned above, the projection of the first region at least partially overlaps the projection of the first conductive member, so that the first conductive plate and the second conductive plate can be welded to the first conductive member through the first region, and a welding parameter is adjusted to correspond to a thickness of the first region, which can improve an effect of the first region being connected to the first conductive member through welding; and the projection of the second region is separated from the projection of the first conductive member, so that when the first conductive plate and the second conductive plate are connected through welding through the second region, a welding parameter corresponds to a thickness of the first conductive plate or the second conductive plate, which can not only improve the welding effect of the second region, but also reduce a length of the first conductive member and save a manufacturing cost of the first conductive member, thereby saving a manufacturing cost of the electrochemical apparatus.

In some embodiments of this application, in a third direction perpendicular to the first direction, a projection of the first region at least partially overlaps a projection of the first conductive member, and a projection of the second region at least partially overlaps the projection of the first conductive member.

In some embodiments of this application, the first battery cell includes a first shell; the second battery cell includes a second shell, and the second shell and the first shell are stacked in the first direction; and in a third direction perpendicular to the first direction, the first conductive member is provided with a first side and a second side opposite to each other, the first shell and the second shell are located on the first side of the first conductive member, and the first region and the second region are located on the second side of the first conductive member. As mentioned above, the first shell and the second shell are located on the first side of the first conductive member, and the first region and the second region are located on the second side of the first conductive member, which is conducive to a welding operation and reduces the welding difficulty, thereby saving an assembly cost of the electrochemical apparatus.

In some embodiments of this application, the electrochemical apparatus further includes a substrate, and the first conductive member is disposed on the substrate; in the third direction, the substrate is provided with a third side and a fourth side opposite to each other, the first shell and the second shell are located on the third side of the substrate, and the first region and the second region are located on the fourth side of the substrate; and in the third direction, the first conductive member is at least partially exposed to the fourth side of the substrate. As mentioned above, the first conductive member is at least partially exposed to the fourth side of the substrate, and the first region and the second region are located on the fourth side of the substrate, which is conducive to the welding operation and reduces the welding difficulty, thereby saving the assembly cost of the electrochemical apparatus.

In some embodiments of this application, the substrate is provided with a first through hole and a second through hole running therethrough, the first through hole and the second through hole are respectively located on two sides of the first conductive member in the first direction, a portion of the first conductive plate passes through the first through hole and is connected to the first conductive member, and a portion of the second conductive plate passes through the second through hole and is connected to the first conductive member. As mentioned above, the portion of the first conductive plate and the portion of the second conductive plate pass through the first through hole and the second through hole respectively and are connected to the first conductive member, which is conducive to improving stability of the first conductive plate and the second conductive plate being connected to the first conductive member.

In some embodiments of this application, in the second direction, a length of the first conductive plate is a third length, and a sum of the first length and the second length is less than the third length; and in the second direction, a length of the second conductive plate is a fourth length, and the sum of the first length and the second length is less than the fourth length.

In some embodiments of this application, a ratio of the sum of the first length and the second length to the third length is greater than or equal to 0.5 and less than or equal to 0.95; and a ratio of the sum of the first length and the second length to the fourth length is greater than or equal to 0.5 and less than or equal to 0.95. The foregoing range of the ratio of the length sum of the first region and the second region to the length of the first conductive plate is conducive to increasing a space utilization rate of the first conductive plate and a space utilization rate of the second conductive plate, thereby improving the welding effect.

In some embodiments of this application, in the second direction, a length of the first conductive member is a fifth length, and the fifth length is not less than the first length.

In some embodiments of this application, a ratio of the first length to the fifth length is greater than or equal to 0.2 and less than or equal to 1.

In some embodiments of this application, in the second direction, a distance between the first region and the second region is a first distance, and the first distance is greater than 0 and less than or equal to 2 mm.

In some embodiments of this application, in a second direction perpendicular to the first direction, a minimum distance between the first region and an end portion of the first conductive plate is a second distance, a minimum distance between the first region and an end portion of the second conductive plate is a third distance, a minimum distance between the first region and an end portion of the first conductive member is a fourth distance, and a minimum value among the second distance, the third distance and the fourth distance is greater than or equal to 0 and less than or equal to 2 mm.

In some embodiments of this application, in a second direction perpendicular to the first direction, a minimum distance between the second region and an end portion of the first conductive plate is a sixth distance, a minimum distance between the second region and an end portion of the second conductive plate is a seventh distance, and a minimum value in the sixth distance and the seventh distance is greater than or equal to 0 and less than or equal to 2 mm.

In some embodiments of this application, in the first direction, a length of the first region is a first dimension, a length of the second region is a second dimension, a length of the first conductive member is a third dimension, and the first dimension and the second dimension are less than the third dimension.

In some embodiments of this application, a ratio of the first dimension to the second dimension is greater than or equal to 0.8 and less than or equal to 1.2; and a ratio of the first dimension to the third dimension is greater than or equal to 0.5 and less than or equal to 0.95.

In some embodiments of this application, the first dimension is not equal to the second dimension.

In some embodiments of this application, the electrochemical apparatus further includes a third battery cell, a fourth battery cell, and a second conductive member. The third battery cell includes a third conductive plate, the third battery cell and the fourth battery cell are stacked in the first direction, and the fourth battery cell includes a fourth conductive plate. The third conductive plate and the fourth conductive plate are stacked on the second conductive member, and the third conductive plate and the fourth conductive plate are connected to the second conductive member through welding. A mutually connected portion of the third conductive plate and the fourth conductive plate includes a third region and a fourth region, the third conductive plate and the fourth conductive plate are welded to the second conductive member in the third region, and the third conductive plate and the fourth conductive plate are connected in the fourth region through welding.

In some embodiments of this application, the fourth region is not connected to the second conductive member through welding.

In some embodiments of this application, the fourth region is welded to the second conductive member.

In some embodiments of this application, in a second direction perpendicular to the first direction, a length of the third region is a sixth length, a length of the fourth region is a seventh length, and the sixth length is not equal to the seventh length.

In some embodiments of this application, the sixth length is less than the seventh length.

In some embodiments of this application, the sixth length is greater than the seventh length.

In some embodiments of this application, in the first direction, a projection of the first region partially overlaps a projection of the third region, and a projection of the second region partially overlaps a projection of the fourth region.

In some embodiments of this application, in the first direction, a projection of the first region partially overlaps a projection of the fourth region, and a projection of the second region partially overlaps a projection of the third region.

In some embodiments of this application, in the first direction, a projection of the third conductive plate is separated from a projection of the first conductive plate and separated from a projection of the second conductive plate, and a projection of the fourth conductive plate is separated from the projection of the first conductive plate and separated from the projection of the second conductive plate.

In some embodiments of this application, in a second direction perpendicular to the first direction, a projection of the third region is separated from a projection of the first region and separated from a projection of the second region, and a projection of the fourth region is separated from the projection of the first region and separated from the projection of the second region.

An embodiment of this application further provides an electrical device. The electrical device includes the electrochemical apparatus according to any one of the foregoing embodiments. In the foregoing electrical device, the first conductive plate, the second conductive plate and the first conductive member of the electrochemical apparatus are mutually welded well, so that the electrochemical apparatus has a relatively low failure rate, which is conducive to reducing the impact of the electrochemical apparatus on the electrical device due to a failure.

### BRIEF DESCRIPTION OF DRAWINGS

FIG. 1 is a schematic structural diagram of an electrochemical apparatus according to an embodiment of this application;

FIG. 2 is an exploded view of the electrochemical apparatus shown in FIG. 1;

FIG. 3 is a schematic structural diagram of a first battery cell according to an embodiment of this application;

FIG. 4 is a schematic structural diagram of a first battery cell before encapsulation according to an embodiment of this application;

FIG. 5 is a schematic structural diagram of a second battery cell according to an embodiment of this application;

FIG. 6 is a schematic structural diagram of battery cell assemblies being connected to a substrate and conductive members according to an embodiment of this application;

FIG. 7 is a view of the structure shown in FIG. 6 in a third direction;

FIG. 8 is an enlarged schematic structural diagram of a region I in FIG. 7 where a first conductive plate is stacked between a second conductive plate and a first conductive member according to an embodiment;

FIG. 9 is a schematic structural diagram of an A-A section in FIG. 8;

FIG. 10 is an enlarged schematic structural diagram of the region I in FIG. 7 where a second conductive plate is stacked between a first conductive plate and a first conductive member according to an embodiment;

FIG. 11 is a schematic structural diagram of a B-B section in FIG. 10;

FIG. 12 is an enlarged schematic structural diagram of the region I in FIG. 7 where a first conductive plate is stacked between a second conductive plate and a first conductive member according to an embodiment;

FIG. 13 is an enlarged schematic structural diagram of the region I in FIG. 7 where a first conductive plate is stacked between a second conductive plate and a first conductive member according to an embodiment;

FIG. 14 is an enlarged schematic structural diagram of the region I in FIG. 7 where a first conductive plate is stacked between a second conductive plate and a first conductive member according to an embodiment;

FIG. 15 is a schematic structural diagram of a C-C section in FIG. 14;

FIG. 16 is an enlarged schematic structural diagram of the region I in FIG. 7 where a first conductive plate is stacked between a second conductive plate and a first conductive member according to an embodiment;

FIG. 17 is an enlarged schematic structural diagram of the region I in FIG. 7 where a first conductive plate is stacked between a second conductive plate and a first conductive member according to an embodiment;

FIG. 18 is a view of a structure of a battery cell assembly being connected to a substrate in a third direction according to an embodiment of this application;

FIG. 19 is a view of a structure of a battery cell assembly being connected to a substrate in a third direction according to an embodiment of this application;

FIG. 20 is a schematic structural diagram of a third battery cell according to an embodiment of this application;

FIG. 21 is a schematic structural diagram of a fourth battery cell according to an embodiment of this application;

FIG. 22 is an enlarged schematic structural diagram of a region II in FIG. 19 where a fourth conductive plate is stacked between a third conductive plate and a second conductive member according to an embodiment;

FIG. 23 is a schematic structural diagram of a D-D section in FIG. 22;

FIG. 24 is an enlarged schematic structural diagram of the region II in FIG. 19 where a third conductive plate is stacked between a fourth conductive plate and a second conductive member according to an embodiment;

FIG. 25 is a schematic structural diagram of an E-E section in FIG. 24;

FIG. 26 is an enlarged schematic structural diagram of the region II in FIG. 19 where a third conductive plate is stacked between a fourth conductive plate and a second conductive member according to an embodiment;

FIG. 27 is an enlarged schematic structural diagram of the region II in FIG. 19 where a third conductive plate is stacked between a fourth conductive plate and a second conductive member according to an embodiment;

FIG. 28 is an enlarged schematic structural diagram of the region II in FIG. 19 where a third conductive plate is stacked between a fourth conductive plate and a second conductive member according to an embodiment;

FIG. 29 is a schematic structural diagram of an F-F section in FIG. 28;

FIG. 30 is an enlarged schematic structural diagram of the region II in FIG. 19 where a third conductive plate is stacked between a fourth conductive plate and a second conductive member according to an embodiment;

FIG. 31 is an enlarged schematic structural diagram of the region II in FIG. 19 where a third conductive plate is stacked between a fourth conductive plate and a second conductive member according to an embodiment;

FIG. 32 is a view of a structure of a battery cell assembly being connected to a substrate in a third direction according to an embodiment of this application;

FIG. 33 is a view of an adapter plate in a third direction according to an embodiment of this application;

FIG. 34 is a view of a structure of a battery cell assembly being connected to a substrate in a third direction according to an embodiment of this application;

FIG. 35 is a view of an adapter plate in a third direction according to an embodiment of this application;

FIG. 36 is a schematic structural diagram of a first structural member being connected to two battery cell assemblies according to an embodiment of this application;

FIG. 37 is an exploded view of a structure shown in FIG. 36; and

FIG. 38 is a schematic structural diagram of an electrical device according to an embodiment of this application.

### REFERENCE NUMERAL DESCRIPTION OF MAIN COMPONENTS

Electrochemical device 100
Shell 10
First wall 11
Second wall 12
Third wall 13
Fourth wall 14
Fifth wall 15
Sixth wall 16
First space 17
Second space 18
Battery cell assembly 20
First battery cell 21
First shell 211
First portion 2111
Second portion 2112
First body portion 2113
First seal edge portion 2114
First top seal edge 21141
First side seal edge 21142
First electrode assembly 212
First conductive plate 213
Fifth conductive plate 214
Second battery cell 22
Second shell 221
Second body portion 2213
Second seal edge portion 2214
Second top seal edge 22141
Second side seal edge 22142
Second conductive plate 222
Sixth conductive plate 223
Third battery cell 23
Third shell 231
Third body portion 2313
Third seal edge portion 2314
Third top seal edge 23141
Third side seal edge 23142
Third conductive plate 232
Seventh conductive plate 233
Fourth battery cell 24
Fourth shell 241
Fourth body portion 2413
Fourth seal edge portion 2414
Fourth top seal edge 24141
Fourth top seal edge 24142
Fourth conductive plate 242
Eighth conductive plate 243
Battery cell unit 25
Battery cell shell 251
Conductive plate 252
Adapter plate 30
Substrate 31
First through hole 311
Second through hole 312
Third through hole 313
Fourth through hole 314
Through hole 315
Third side 316
Fourth side 317
Eighth through hole 318
Ninth through hole 319
First conductive member 32
First side 321
Second side 322
Second conductive member 33
Conductive member 34
Circuit board 40
First region 51
Second region 52
Third region 53
Fourth region 54
First structural member 61
Second structural member 62
First bottom plate 621
First side wall 622
Second side wall 623
First terminal 71
Second terminal 72
Wiring harness 73
Connecting member 74
First insulation member 81
Second insulation member 82
Fifth through hole 821
Sixth through hole 822
Seventh through hole 823
Electric device 200
First direction X
Second direction Y
Third direction Z
First length L1
Second length L2
Third length L3
Fourth length L4
Fifth length L5
Sixth length L6
Seventh length L7
Eighth length L8
Ninth length L9
Tenth length L10
First dimension W1
Second dimension W2
Third dimension W3
Fourth dimension W4
Fifth dimension W5
Sixth dimension W6
First distance D1
Second distance D2
Third distance D3
Fourth distance D4
Fifth distance D5
Sixth distance D6
Seventh distance D7
Eighth distance D8
Ninth distance D9
Tenth distance D10
Eleventh distance D11
Twelfth distance D12
Thirteenth distance D13

This application is further described by using the following specific implementations with reference to the foregoing accompanying drawings.

### DETAILED DESCRIPTION

Technical solutions in embodiments of this application will be described below in conjunction with accompanying drawings in the embodiments of this application. Apparently, the described embodiments are merely some rather than all of the embodiments of this application. Accordingly, the following detailed description of the embodiments of this application provided in the accompanying drawings is not intended to limit the scope of this application for which protection is claimed, but to merely represent selected embodiments of this application.

It is to be noted that when one component is referred to as being “connected to” another component, it may be directly connected to the another component, or there may be a component disposed therebetween. When one component is referred to as being “disposed on” another component, it may be directly disposed on the another component, or there may be a component disposed therebetween. In this application, unless otherwise expressly specified and limited, the terms “mounted”, “connected”, “connect”, “fixed” and the like are to be understood in a broad sense, for example, it may be a fixed connection, or a removable connection, or an integral connection; it may be a mechanical connection or an electrical connection; and it may be a direct connection or indirect connection through an intermediate medium, and may be the interior communication between two components. For a person of ordinary skill in the art, the specific meaning of the forgoing terms in this application may be understood according to specific circumstances.

Unless otherwise defined, all technical and scientific terms used herein have the same meanings as commonly understood by a person skilled in the technical field to which this application pertains. The terms used in the specification of this application are merely intended to describe specific embodiments but not to limit this application. The terms “comprise”, “have”, and any other variations thereof in the specification, claims and accompanying drawings of this application are intended to cover non-exclusive inclusions.

In the description of the embodiments of this application, the technical terms “first”, “second”, and the like are merely used to distinguish between different objects, and shall not be construed as any indication or implication of relative importance or any implicit indication of the quantity, particular sequence or primary-secondary relationship of the technical features indicated. In the description of the embodiments of this application, “a plurality of” means two or more unless otherwise expressly and specifically defined.

Reference herein to “embodiment(s)” means that specific features, structures or characteristics described with reference to the embodiment(s) may be incorporated in at least one embodiment of this application. The word “embodiment(s)” appearing in various positions in the specification does not necessarily refer to the same embodiment or an independent or alternative embodiment that is exclusive of other embodiments. It is explicitly or implicitly understood by a person skilled in the art that the embodiments described herein may be combined with other embodiments.

It is to be noted that the thickness, length, width, and other dimensions of the various components in the embodiments of this application, as well as the overall thickness, length, width, and other dimensions of an integrated apparatus, shown in the accompanying drawings, are merely exemplary illustrations and shall not constitute any limitation on this application.

An embodiment of this application provides an electrochemical apparatus. The electrochemical apparatus includes a first battery cell, a second battery cell, and a first conductive member. The first battery cell includes a first conductive plate, the second battery cell and the first battery cell are stacked in a first direction, and the second battery cell includes a second conductive plate. The first conductive plate and the second conductive plate are stacked on the first conductive member, and the first conductive plate and the second conductive plate are connected to the first conductive member through welding. A mutually connected portion of the first conductive plate and the second conductive plate includes a first region and a second region, the first conductive plate and the second conductive plate are welded to the first conductive member in the first region, the first conductive plate and the second conductive plate are connected in the second region through welding, and the second region is not connected to the first conductive member through welding.

In the foregoing electrochemical apparatus, the first conductive plate and the second conductive plate are welded to the first conductive member in the first region, and the first conductive plate and the second conductive plate are connected in the second region through welding, so that different welding parameters can be respectively applied to the first region and the second region, thereby improving a welding effect of the first region and a welding effect of the second region, and reducing a risk of poor welding.

Embodiments of this application are further illustrated below with reference to the accompanying drawings.

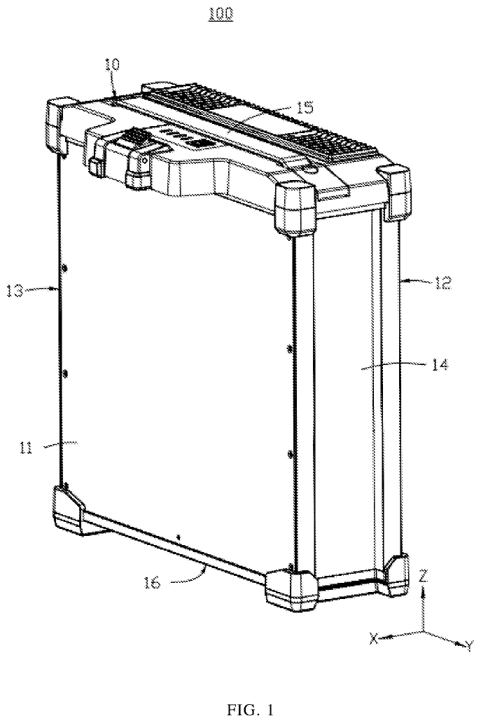

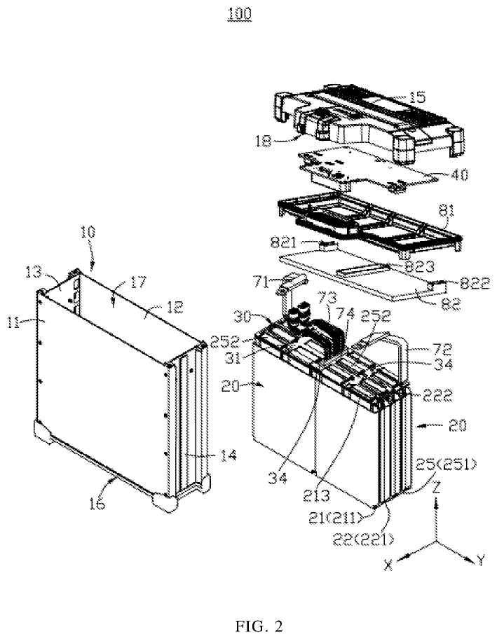

As shown in FIG. 1 and FIG. 2, an implementation of this application provides an electrochemical apparatus 100. The electrochemical apparatus 100 includes a shell 10, battery cell assemblies 20, an adapter plate 30, and a circuit board 40. The battery cell assemblies 20, the adapter plate 30 and the circuit board 40 are disposed in the shell 10, and the adapter plate 30 is connected to the battery cell assemblies 20 and the circuit board 40, so that the battery cell assemblies 20 are electrically connected to the circuit board 40.

In an embodiment, the shell 10 includes a first wall 11, a second wall 12, a third wall 13, a fourth wall 14, a fifth wall 15, and a sixth wall 16. The first wall 11 and the second wall 12 are oppositely disposed in a first direction X. The third wall 13 and the fourth wall 14 are oppositely disposed in a second direction Y perpendicular to the first direction X. The fifth wall 15 and the sixth wall 16 are oppositely arranged in a third direction Z perpendicular to the first direction X and the second direction Y. Both the fifth wall 15 and the sixth wall 16 are connected to the first wall 11, the second wall 12, the third wall 13 and the fourth wall 14. A cavity space capable of accommodating the battery cell assemblies 20, the adapter plate 30 and the circuit board 40 is defined by the first wall 11, the second wall 12, the third wall 13, the fourth wall 14, the fifth wall 15, and the sixth wall 16.

In an embodiment, the circuit board 40 includes a battery management system (BMS) assembly. The BMS assembly includes a plurality of electron components, and the plurality of electronic components can realize functions of data acquisition, control, protection, communication, power calculation, signal transmission, power transmission, etc. for the battery cell assemblies 20.

The battery cell assembly 20 includes a first battery cell 21 and a second battery cell 22. The first battery cell 21 and the second battery cell 22 are stacked in the first direction X. The first battery cell 21 includes a first conductive plate 213. The second battery cell 22 includes a second conductive plate 222. The first conductive plate 213 and the second conductive plate 222 are mutually connected. Both the first conductive plate 213 and the second conductive plate 222 are connected to the adapter plate 30.

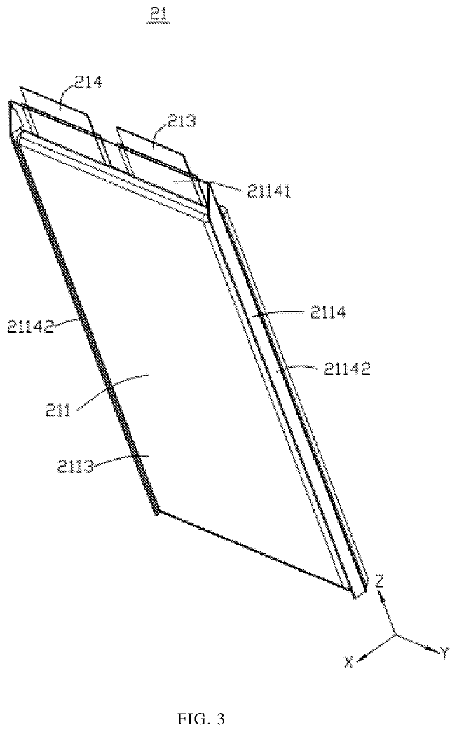

As shown in FIG. 3 and FIG. 4, the first battery cell 21 further includes a first shell 211, a first electrode assembly 212, and a fifth conductive plate 214. The first electrode assembly 212 is disposed in the first shell 211. Both the first conductive plate 213 and the fifth conductive plate 214 are connected to the first electrode assembly 212 and stretch out of the first shell 211.

One of the first conductive plate 213 and the fifth conductive plate 214 serves as a positive conductive plate, and the other one of the first conductive plate 213 and the fifth conductive plate 214 serves as a negative conductive plate. Optionally, the first conductive plate 213 serves as the positive conductive plate, and the fifth conductive plate 214 serves as the negative conductive plate.

The first electrode assembly 212 includes a positive electrode plate, a negative electrode plate, and a separator (not shown in the figure). The separator is disposed between the positive electrode plate and the negative electrode plate. The positive electrode plate, the separator and the negative electrode plate are wound or stacked to form the first electrode assembly 212. The first conductive plate 213 is connected to the positive electrode plate, and the fifth conductive plate 214 is connected to the negative electrode plate.

In an embodiment, the first shell 211 includes a first portion 2111 and a second portion 2112. After being attached in opposite directions, the first portion 2111 and the second portion 2112 may form an internal space capable of accommodating the first electrode assembly 212.

In an embodiment, the first shell 211 includes a first body portion 2113 and a first seal edge portion 2114. The first seal edge portion 2114 is connected to the first body portion 2113 and extends from the first body portion 2113. The first electrode assembly 212 is disposed in the first body portion 2113. The first conductive plate 213 and the fifth conductive plate 214 stretch out of the first seal edge portion 2114.

In an embodiment, the first seal edge portion 2114 includes a first side seal edge 21142 and a first top seal edge 21141 that are mutually connected. The first conductive plate 213 and the fifth conductive plate 214 stretch out of the first top seal edge 21141. The first top seal edge 21141 is located on an end portion of the first body portion 2113 in the third direction Z, and the first side seal edge 21142 is located on an end portion of the first body portion 2113 in the second direction Y.

In an embodiment, the first conductive plate 213 and the fifth conductive plate 214 are located on the same side of the first body portion 2113 in the third direction Z.

Exemplarily, a further illustration is made below by taking the first conductive plate 213 and the fifth conductive plate 214 being located on the same side of the first body portion 2113 in the third direction Z as an example.

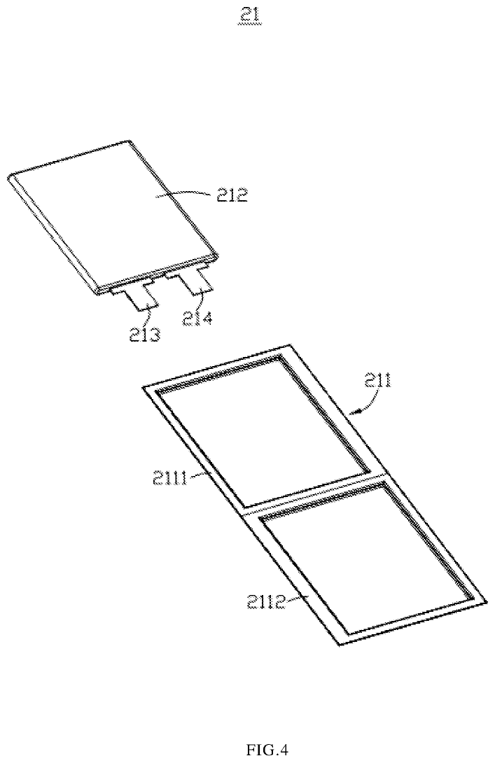

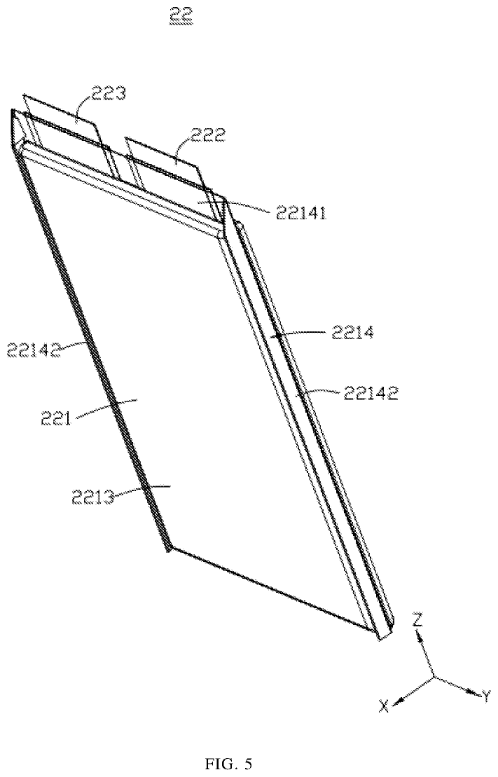

As shown in FIG. 5, the second battery cell 22 further includes a second shell 221, a second electrode assembly (not shown in the figure), and a sixth conductive plate 223. The second electrode assembly is disposed in the second shell 221. Both the second conductive plate 222 and the sixth conductive plate 223 are connected to the second electrode assembly and stretch out of the second shell 221.

One of the second conductive plate 222 and the sixth conductive plate 223 serves as a positive conductive plate, and the other one of the second conductive plate 222 and the sixth conductive plate 223 serves as a negative conductive plate. Optionally, the second conductive plate 222 serves as the negative conductive plate, and the sixth conductive plate 223 serves as the positive conductive plate.

In an embodiment, the second electrode assembly has the same structure as the first electrode assembly 212, which will not be described in detail in this application.

In an embodiment, the second shell 221 includes a second body portion 2213 and a second seal edge portion 2214. The second seal edge portion 2214 is connected to the second body portion 2213 and extends from the second body portion 2213. The second electrode assembly is disposed in the second body portion 2213. The second conductive plate 222 and the sixth conductive plate 223 stretch out of the second seal edge portion 2214.

In an embodiment, the second seal edge portion 2214 includes a second side seal edge 22142 and a second top seal edge 22141 that are mutually connected. The second conductive plate 222 and the sixth conductive plate 223 stretch out of the second top seal edge 22141. The second top seal edge 22141 is located on an end portion of the second body portion 2213 in the third direction Z, and the second side seal edge 22142 is located on an end portion of the second body portion 2213 in the second direction Y.

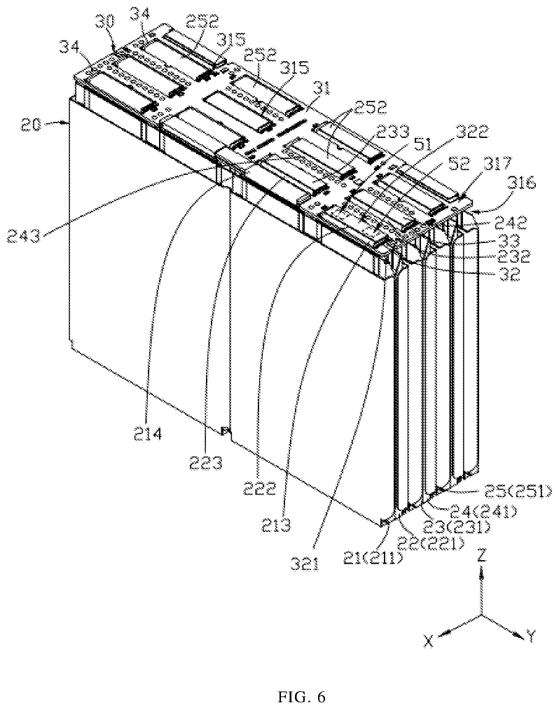

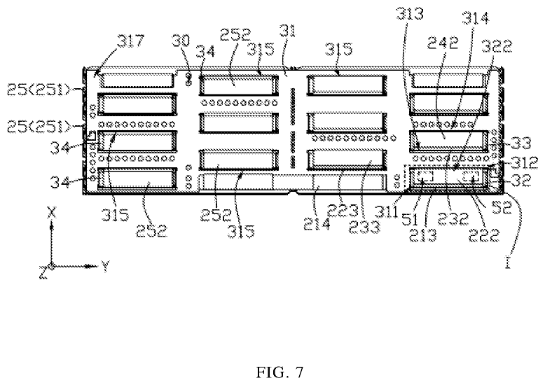

As shown in FIG. 6 and FIG. 7, the adapter plate 30 includes a substrate 31. In the third direction Z, the substrate 31 is provided with a third side 316 and a fourth side 317 opposite to each other. The first shell 211 and the second shell 221 are disposed on the third side 316 of the substrate 31. The first conductive plate 213 and the second conductive plate 222 pass through the substrate 31 and are connected to the fourth side 317 of the substrate 31.

The adapter plate 30 further includes a first conductive member 32. The first conductive member 32 is disposed on the substrate 31 and at least partially exposed to the fourth side 317 of the substrate 31. In some embodiments, in the third direction Z, the first conductive member 32 is provided with a first side 321 and a second side 322 opposite to each other. The first shell 211 and the second shell 221 are disposed on the first side 321 of the first conductive member 32. The first conductive plate 213 and the second conductive plate 222 pass through the substrate 31 and are connected to the second side 322 of the first conductive member 32 in a stacked manner. The first conductive plate 213 and the second conductive plate 222 are connected to the first conductive member 32 through welding, where on the second side 322 of the first conductive member 32, in the third direction Z, the conductive plate in the first conductive plate 213 and the second conductive plate 222 close to the first conductive member 32 is connected to the first conductive member 32 through welding, and the conductive plate in the first conductive plate 213 and the second conductive plate 222 away from the first conductive member 32 is connected to the first conductive member 32 through the conductive plate close to the first conductive member 32.

A mutually connected portion of the first conductive plate 213 and the second conductive plate 222 includes a first region 51 and a second region 52. The first region 51 and the second region 52 are located on the second side 322 of the first conductive member 32. The first conductive plate 213 and the second conductive plate 222 are welded to the first conductive member 32 in the first region 51. The first conductive plate 213 and the second conductive plate 222 are connected in the second region 52 through welding. The second region 52 is not connected to the first conductive member 32 through welding.

In the electrochemical apparatus 100 of this application, the first conductive plate 213 and the second conductive plate 222 are welded to the first conductive member 32 in the first region 51, and the first conductive plate 213 and the second conductive plate 222 are connected in the second region 52 through welding, so that different parameters can be respectively applied to the first region 51 and the second region 52, thereby improving a welding effect of the first region 51 and a welding effect of the second region 52, and reducing a risk of poor welding. Optionally, the welding parameters include welding power.

In an embodiment, a portion of the first conductive member 32 is embedded in the substrate 31, and a portion of the first conductive member 32 is exposed to the fourth side 317 of the substrate 31. In an embodiment, the first conductive member 32 and the substrate 31 are integrally formed, which can improve connecting stability of the first conductive member 32 and the substrate 31 and improve production efficiency. In an embodiment, the first conductive member 32 and the substrate 31 are integrally formed through injection molding.

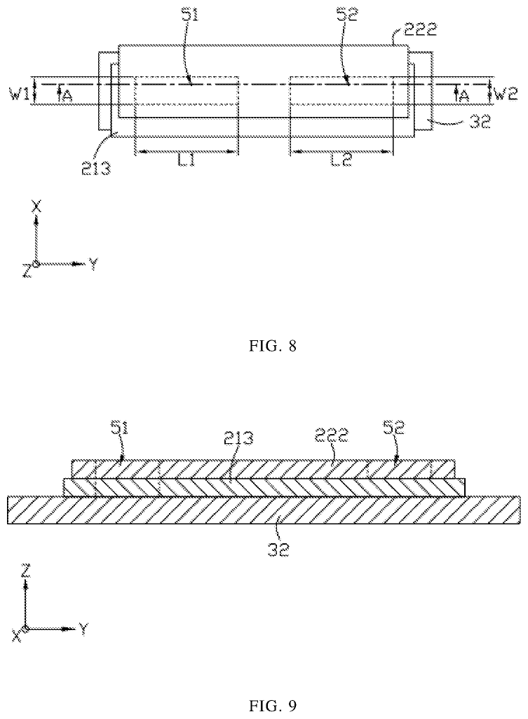

As shown in FIG. 8 and FIG. 9, in an embodiment, in the third direction Z, the first conductive plate 213 is located between the second conductive plate 222 and the first conductive member 32 and connected to the second conductive plate 222 and the first conductive member 32.

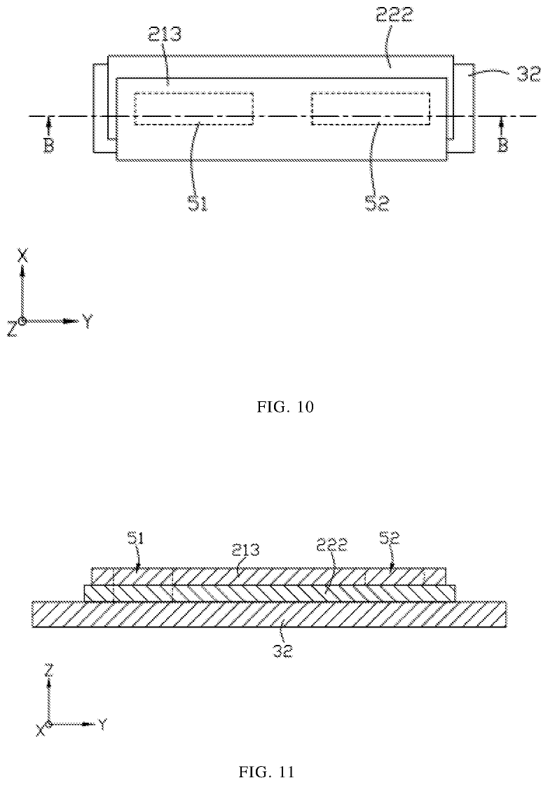

As shown in FIG. 10 and FIG. 11, in an embodiment, in the third direction Z, the second conductive plate 222 is located between the first conductive plate 213 and the first conductive member 32 and connected to the first conductive plate 213 and the first conductive member 32.

Exemplarily, a further illustration is made below by taking the first conductive plate 213 being stacked between the second conductive plate 222 and the first conductive member 32 in the third direction Z (as shown in FIG. 8 and FIG. 9) as an example.

Referring in conjunction to FIG. 7, FIG. 8 and FIG. 9, when the first conductive plate 213 and the second conductive plate 222 are welded to the first conductive member 32 in the first region 51, a welding machine needs to strike through the first conductive plate 213 and the second conductive plate 222 and act on a connecting face of the second conductive plate 222 and the first conductive member 32. When the first conductive plate 213 and the second conductive plate 222 are connected in the second region 52 through welding, the welding machine needs to strike through the first conductive plate 213 and act on a connecting face of the first conductive plate 213 and the second conductive plate 222. It can be seen by comparison that the welding machine needs to strike through different thicknesses and needs different power during welding in the first region 51 and the second region 52. According to the electrochemical apparatus 100 of this application, by respectively applying the different welding power to the first region 51 and the second region 52, the welding effect of the first region 51 and the welding effect of the second region 52 can be improved, and the risk of poor welding is reduced.

In an embodiment, the substrate 31 is provided with a first through hole 311 and a second through hole 312 running therethrough. The first conductive member 32 is located between the first through hole 311 and the second through hole 312 in the first direction X. A portion of the second conductive plate 222 runs through the second through hole 312, and is bend towards the first conductive member 32 on the fourth side 317 and connected to the first conductive member 32. A portion of the first conductive plate 213 runs through the first through hole 311, and is bent towards the first conductive member 32 on the fourth side 317 and connected to the second conductive plate 222.

In an embodiment, the first region 51 is disposed in the second direction Y. A length of the first region 51 in the second direction Y is a first length L1, and a length of the first region 51 in the first direction X is a first dimension W1, where L1>W1. The first region 51 can utilize spaces of the first conductive plate 213 and the second conductive plate 222 in the second direction Y and a space of the first conductive member 32 in the second direction Y, so that space utilization rates of the first conductive plate 213 and the second conductive plate 222 are increased, which is conducive for the first conductive plate 213 and the second conductive plate 222 to dissipate heat, thereby increasing heat dissipating rates of the first battery cell 21 and the second battery cell 22, and reducing the impact of the length of the first region 51 in the first direction X on the size of the first conductive member 32.

In an embodiment, the second region 52 is disposed in the second direction Y. A length of the second region 52 in the second direction Y is a second length L2, and a length of the second region 52 in the first direction X is a second dimension W2, where L2>W2. The second region 52 can utilize the spaces of the first conductive plate 213 and the second conductive plate 222 in the second direction Y, so that the space utilization rates of the first conductive plate 213 and the second conductive plate 222 are increased, which is conducive for the first conductive plate 213 and the second conductive plate 222 to dissipate heat, thereby increasing the heat dissipating rates of the first battery cell 21 and the second battery cell 22.

In an embodiment, the first length L1 is equal to the second length L2.

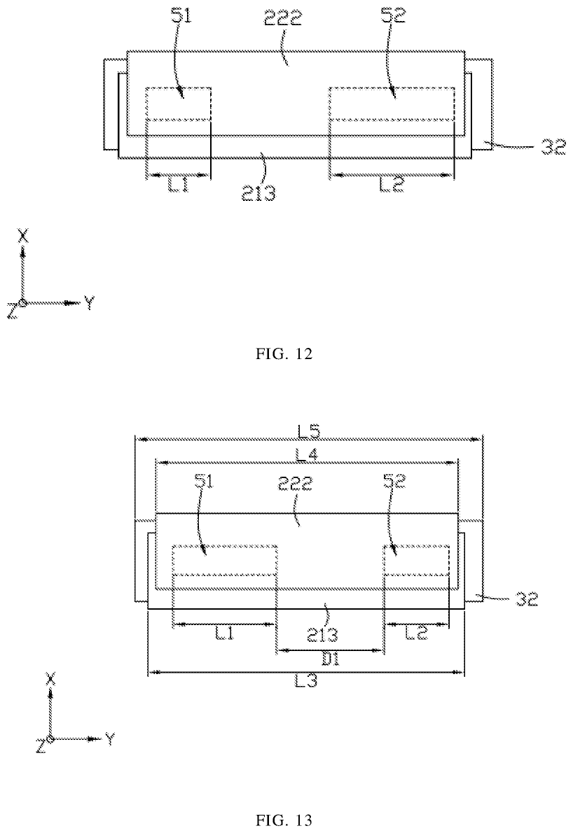

As shown in FIG. 12, in an embodiment, the first length L1 is not equal to the second length L2. In an embodiment, the first length L1 is less than the second length L2.

As shown in FIG. 13, in an embodiment, the first length L1 is greater than the second length L2.

In an embodiment, in the second direction Y, a length of the first conductive plate 213 is a third length L3, where (L1+L2)<L3. In an embodiment, 0.50≤(L1+L2)/L3≤0.95, which is conducive for the first region 51 and the second region 52 to utilize the space of the first conductive plate 213 in the second direction Y, thereby increasing the space utilization rate of the first conductive plate 213; and a connecting area of the first conductive plate 213 and the second conductive plate 222 is increased, which is conducive for the first conductive plate 213 and the second conductive plate 222 to dissipate heat, thereby increasing the heat dissipating rates of the first battery cell 21 and the second battery cell 22.

In an embodiment, 0.75≤(L1+L2)/L3≤0.95, which can further increase the space utilization rate of the first conductive plate 213, and the connecting area of the first conductive plate 213 and the second conductive plate 222 is increased, which is conducive for the first conductive plate 213 and the second conductive plate 222 to dissipate heat, thereby increasing the heat dissipating rates of the first battery cell 21 and the second battery cell 22.

In an embodiment, a value of (L1+L2)/L3 is any one of 0.50, 0.55, 0.60, 0.65, 0.70, 0.75, 0.80, 0.85, 0.90, and 0.95. In an embodiment, the value of (L1+L2)/L3 is a result correct to two decimal places.

In an embodiment, in the second direction Y, a length of the second conductive plate 222 is a fourth length L4, where (L1+L2)<L4. In an embodiment, 0.50≤(L1+L2)/L4≤0.95, which is conducive for the first region 51 and the second region 52 to utilize the space of the second conductive plate 222 in the second direction Y, thereby increasing the space utilization rate of the second conductive plate 222; and the connecting area of the first conductive plate 213 and the second conductive plate 222 is increased, which is conducive for the first conductive plate 213 and the second conductive plate 222 to dissipate heat, thereby increasing the heat dissipating rates of the first battery cell 21 and the second battery cell 22.

In an embodiment, 0.75≤(L1+L2)/L4≤0.95, which can further increase the space utilization rate of the second conductive plate 222, and the connecting area of the first conductive plate 213 and the second conductive plate 222 is increased, which is conducive for the first conductive plate 213 and the second conductive plate 222 to dissipate heat, thereby increasing the heat dissipating rates of the first battery cell 21 and the second battery cell 22.

In an embodiment, a value of (L1+L2)/L4 is any one of 0.50, 0.55, 0.60, 0.65, 0.70, 0.75, 0.80, 0.85, 0.90, and 0.95. In an embodiment, the value of (L1+L2)/L4 is a result correct to two decimal places.

In an embodiment, in the second direction Y, a length of the first conductive member 32 is a fifth length L5, where L1≤L5. In an embodiment, 0.20≤L1/L5≤1, which is conducive for the first region 51 to utilize the space of the first conductive member 32 in the second direction Y, thereby increasing a space utilization rate of the first conductive member 32, and a connecting area of the first conductive plate 213, the second conductive plate 222 and the first conductive member 32 is increased, which is conducive for the first conductive plate 213 and the second conductive plate 222 to dissipate heat through the first conductive member 32, thereby increasing the heat dissipating rates of the first battery cell 21 and the second battery cell 22.

In an embodiment, 0.60≤L1/L5≤1, which can further increase the space utilization rate of the first conductive member 32, and the connecting area of the first conductive plate 213, the second conductive plate 222 and the first conductive member 32 is increased, which is conducive for the first conductive plate 213 and the second conductive plate 222 to dissipate heat through the first conductive member 32, thereby increasing the heat dissipating rates of the first battery cell 21 and the second battery cell 22.

In an embodiment, a value of L1/L5 is any one of 0.20, 0.25, 0.30, 0.35, 0.40, 0.45, 0.50, 0.55, 0.60, 0.65, 0.70, 0.75, 0.80, 0.85, 0.90, 0.95, and 1.0. In an embodiment, the value of L1/L5 is a result correct to two decimal places.

In an embodiment, in the second direction Y, a distance between the first region 51 and the second region 52 is a first distance D1, where 0<D1≤2 mm, which can not only provide enough travel time for the welding machine to adjust a welding parameter, but also reduce the impact of the first distance D1 on the lengths of the first conductive plate 213 and the second conductive plate 222 in the second direction Y, thereby increasing the space utilization rate of the first conductive plate 213 and the space utilization rate of the second conductive plate 222.

In an embodiment, 0.5 mm≤D1≤1.5 mm.

In an embodiment, a value of D1 is any one of 0.1 mm, 0.2 mm, 0.3 mm, 0.4 mm, 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9, and 2 mm.

In an embodiment, in the third direction Z, a projection of the second region 52 at least partially overlaps a projection of the first conductive member 32. When the second region 52 shakes relative to the first conductive member 32, the first conductive member 32 can make contact with the second region 52 and provide supporting force for the second region 52 to reduce the impact of shaking of the second region 52 on the first region 51 being connected to the first conductive member 32, thereby improving seismic performance of the electrochemical apparatus 100.

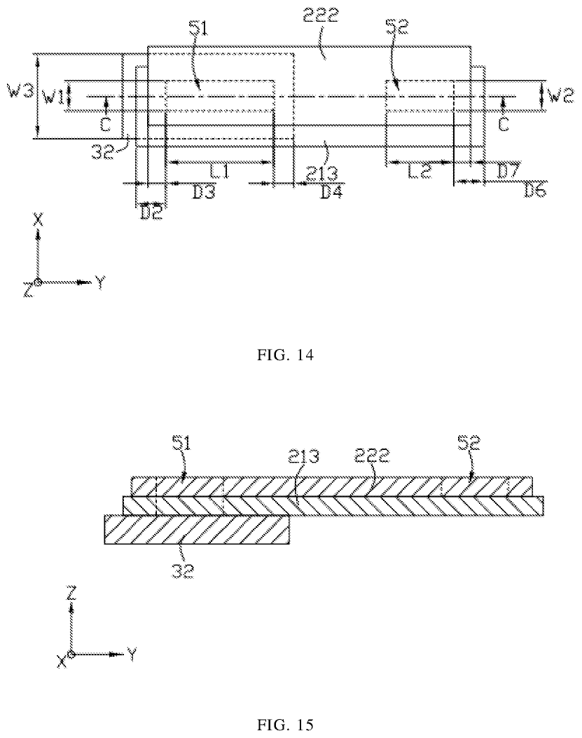

As shown in FIG. 14 and FIG. 15, in an embodiment, in the third direction Z, the projection of the second region 52 is separated from the projection of the first conductive member 32, which is conducive for the first conductive plate 213 and the second conductive plate 222 to be connected through welding through the second region 52, and by adjusting the welding power according to a thickness of an upper-layer conductive plate 252, the welding effect of the second region 52 can be improved, and electric energy is saved. Furthermore, the length of the first conductive member 32 in the second direction Y can further be reduced, and a manufacturing cost of the first conductive member 32 is saved, thereby saving a manufacturing cost of the electrochemical apparatus 100. Moreover, through the reduction of the length of the first conductive member 32, an area of the first conductive member being connected to the substrate 31 can be reduced, and when the first conductive member 32 is heated up, a risk of deformation of the substrate 31 caused by uneven temperature distribution can be reduced.

Exemplarily, a further illustration is made below by taking the projection of the second region 52 being separated from the projection of the first conductive member 32 in the third direction Z as an example.

In an embodiment, in the second direction Y, a minimum distance between the first region 51 and an end portion of the first conductive plate 213 is a second distance D2, a minimum distance between the first region 51 and an end portion of the second conductive plate 222 is a third distance D3, and a minimum distance between the first region 51 and an end portion of the first conductive member 32 is a fourth distance D4. A minimum value among the second distance D2, the third distance D3 and the fourth distance D4 ranges from 0 mm to 2 mm, which is conducive to increasing the space utilization rate of the first conductive plate 213, the space utilization rate of the second conductive plate 222 and the space utilization rate of the first conductive member 32.

In an embodiment, the minimum value among the second distance D2, the third distance D3 and the fourth distance D4 is any one of 0 mm, 0.2 mm, 0.4 mm, 0.6 mm, 0.8 mm, 1 mm, 1.2 mm, 1.4 mm, 1.6 mm, 1.8 mm, and 2 mm.

In this application, in the second direction Y, the first region 51 is provided with two opposite end portions, and the first conductive plate 213 is provided with two opposite end portions. There are two distances between one end of the first region 51 and the two end portions of the first conductive plate 213, and there are two distances between the other end of the first region 51 and the two end portions of the first conductive plate 213. That is, there are a total of four distances between the two end portions of the first region 51 and the two end portions of the first conductive plate 213. The second distance D2 is the minimum distance among the four distances.

In this application, in the second direction Y, the first region 51 is provided with two opposite end portions, and the second conductive plate 222 is provided with two opposite end portions. There are two distances between one end of the first region 51 and the two end portions of the second conductive plate 222, and there are two distances between the other end of the first region 51 and the two end portions of the second conductive plate 222. That is, there are a total of four distances between the two end portions of the first region 51 and the two end portions of the second conductive plate 222. The third distance D3 is the minimum distance among the four distances.

In this application, in the second direction Y, the first region 51 is provided with two opposite end portions, and the first conductive member 32 is provided with two opposite end portions. There are two distances between one end of the first region 51 and the two end portions of the first conductive member 32. There are two distances between the other end of the first region 51 and the two end portions of the first conductive member 32. That is, there are a total of four distances between the two end portions of the first region 51 and the two end portions of the first conductive member 32. The fourth distance D4 is the minimum distance among the four distances.

In an embodiment, in the second direction Y, a minimum distance between the second region 52 and the end portion of the first conductive plate 213 is a sixth distance D6, and a minimum distance between the second region 51 and the end portion of the second conductive plate 222 is a seventh distance D7. A minimum value in the sixth distance D6 and the seventh distance D7 ranges from 0 mm to 2 mm, which is conducive to increasing the space utilization rate of the first conductive plate 213 and the space utilization rate of the second conductive plate 222.

In an embodiment, the minimum value in the sixth distance D6 and the seventh distance D7 is any one of 0 mm, 0.2 mm, 0.4 mm, 0.6 mm, 0.8 mm, 1 mm, 1.2 mm, 1.4 mm, 1.6 mm, 1.8 mm, and 2 mm.

In this application, in the second direction Y, the second region 52 is provided with two opposite end portions, and the first conductive plate 213 is provided with two opposite end portions. There are two distances between one end of the second region 52 and the two end portions of the first conductive plate 213, and there are two distances between the other end of the second region 52 and the two end portions of the first conductive plate 213. That is, there are a total of four distances between the two end portions of the second direction 52 and the two end portions of the first conductive plate 213. The sixth distance D6 is the minimum distance among the four distances.

In this application, in the second direction Y, the second region 52 is provided with two opposite end portions, and the second conductive plate 222 is provided with two opposite end portions. There are two distances between one end of the second region 52 and the two end portions of the second conductive plate 222, and there are two distances between the other end of the second region 52 and the two end portions of the second conductive plate 222. That is, there are a total of four distances between the two end portions of the second region 52 and the two end portions of the second conductive plate 222. The seventh distance D7 is the minimum distance among the four distances.

In an embodiment, in the first direction X, a length of the first region 51 is a first dimension W1, and a length of the second region 52 is a second dimension W2, where 0.8≤W1/W2≤1.2, which is conducive for the welding machine to continuously weld the first region 51 and the second region 52 to reduce a parameter difference when the welding machine welds the first region 51 and the second region 52 and to improve consistency of the welding effects. In an embodiment, a value of W1/W2 is any one of 0.8, 0.9, 1, 1.1 and 1.2.

In an embodiment, the first dimension W1 is not equal to the second dimension W2. In an embodiment, the first dimension W1 is greater than the second dimension W2. In an embodiment, the first dimension W1 is less than the second dimension W2.

In an embodiment, in the first direction X, a length of the first conductive member 32 is a third dimension W3, where W1<W3, and W2<W3. In an embodiment, 0.50≤W1/W3≤0.95, which is conducive to increasing the space utilization rate of the first conductive member 32, and improving stability of the first region 51 being connected to the first conductive member 32. In an embodiment, 0.70≤W1/W3≤0.95, which can further increase the space utilization rate of the first conductive member 32, and improve the stability of the first region 51 being connected to the first conductive member 32.

In an embodiment, a value of W1/W3 is any one of 0.50, 0.55, 0.60, 0.65, 0.70, 0.75, 0.80, 0.85, 0.90, and 0.95. In an embodiment, the value of W1/W3 is a result correct to two decimal places.

As shown in FIG. 14, in an embodiment, in the second direction Y, a projection of the first region 51 overlaps a projection of the second region 52, which is conducive for the welding machine to continuously weld the first region 51 and the second region 52 to reduce the parameter difference when the welding machine welds the first region 51 and the second region 52 and to improve the consistency of the welding effects.

As shown in FIG. 16, in an embodiment, in the second direction Y, the projection of the first region 51 partially overlaps the projection of the second region 52, which is conducive for the first conductive plate 213 and the second conductive plate 222 to evenly dissipate heat, so as to reduce a temperature difference between the first battery cell 21 and the second battery cell 22 and reduce the impact of the temperature difference on charge and discharge performance of the battery cell assembly 20.

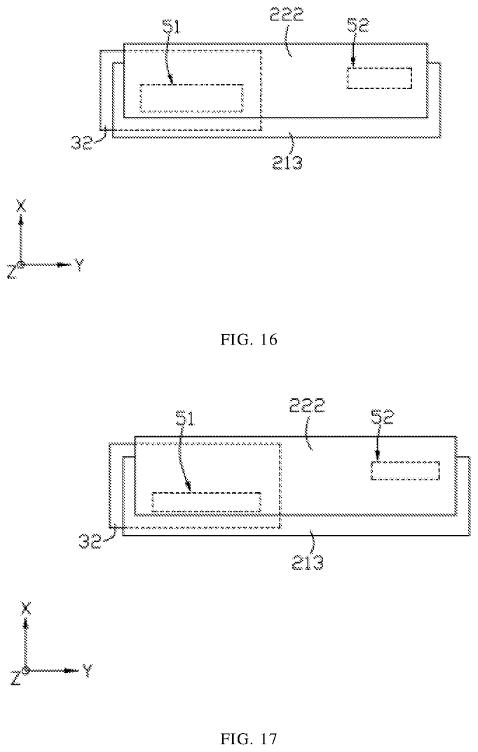

As shown in FIG. 17, in an embodiment, in the second direction Y, the projection of the first region 51 is separated from the projection of the second region 52, which is conducive for the first conductive plate 213 and the second conductive plate 222 to evenly dissipate heat, so as to reduce the temperature difference between the first battery cell 21 and the second battery cell 22 and reduce the impact of the temperature difference on the charge and discharge performance of the battery cell assembly 20.

Still referring to FIG. 6 and FIG. 7, in an embodiment, the electrochemical apparatus 100 further includes a third battery cell 23 and a fourth battery cell 24. The third battery cell 23 and the fourth battery cell 24 are stacked in the first direction X. The adapter plate 30 further includes a second conductive member 33, and the second conductive member 33 is disposed on the substrate 31 and located on the same side of the substrate 31 as the first conductive member 32. The third battery cell 23 includes a third conductive plate 232, and the fourth battery cell 24 includes a fourth conductive plate 242. A portion of the third conductive plate 232 and a portion of the fourth conductive plate 242 run through the substrate 31 and are stacked on the second conductive member 33. The third conductive plate 232 and the fourth conductive plate 242 are connected to the second conductive member 33 through welding.

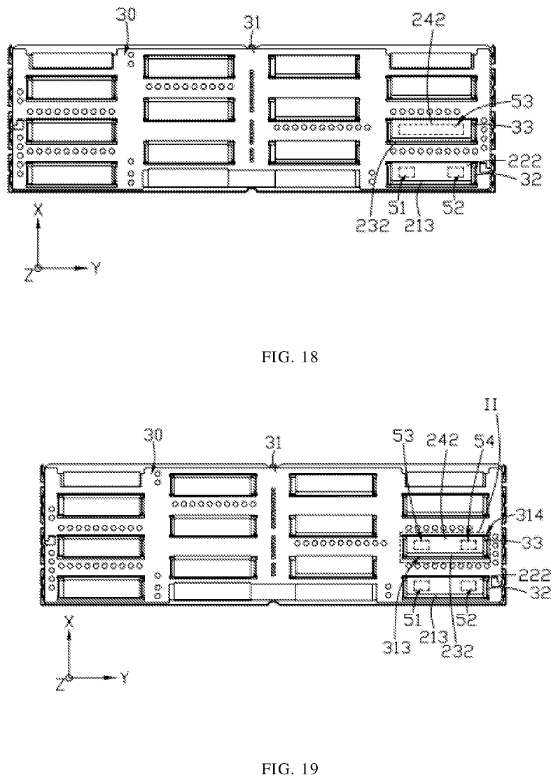

As shown in FIG. 18, in an embodiment, a mutually connected portion of the third conductive plate 232 and the fourth conductive plate 242 includes a third region 53. The third region 53, the first region 51 and the second region 52 are located on the same side of the substrate 31. The third conductive plate 232 and the fourth conductive plate 242 are welded to the second conductive member 33 in the third region 53.

As shown in FIG. 19, in an embodiment, a mutually connected portion of the third conductive plate 232 and the fourth conductive plate 242 further includes a fourth region 54. The third region 53, the fourth region 54, the first region 51 and the second region 52 are located on the same side of the substrate 31. The third conductive plate 232 and the fourth conductive plate 242 are connected in the fourth region 54 through welding. According to the electrochemical apparatus 100, the third conductive plate 232 and the fourth conductive plate 242 are welded to the second conductive member 33 in the third region 53, and the third conductive plate 232 and the fourth conductive plate 242 are connected in the fourth region 54 through welding, so that different welding power can be respectively applied to the third region 53 and the fourth region 54 to improve a welding effect of the third region 53 and a welding effect of the fourth region 54 and to reduce the risk of poor welding.

In an embodiment, the fourth region 54 is not connected to the second conductive member 33 through welding. When the third conductive plate 232 and the fourth conductive plate 242 are welded to the second conductive member 33 in the third region 53, the welding machine needs to strike through the third conductive plate 232 and the fourth conductive plate 242 and act on a connecting face of a lower-layer conductive plate 252 and the second conductive member 33. When the third conductive plate 232 and the fourth conductive plate 242 are connected in the fourth region 54 through welding, the welding machine needs to strike through the upper-layer conductive plate 252 and act on a connecting face of the third conductive plate 232 and the fourth conductive plate 242. It can be seen by comparison that the welding machine needs to strike through different thicknesses and needs different power during welding in the third region 53 and the fourth region 54. According to the electrochemical apparatus 100 of this application, by respectively applying the different welding power to the third region 53 and the fourth region 54, the welding effect of the third region 53 and the welding effect of the fourth region 54 can be improved, and the risk of poor welding is reduced.

In an embodiment, the fourth region 54 is welded to the second conductive member 33, which can improve stability of the third conductive plate 232 and the fourth conductive plate 242 being connected to the second conductive member 33, thereby improving the seismic performance of the electrochemical apparatus 100.

In an embodiment, a portion of the second conductive member 33 is embedded in the substrate 31. In an embodiment, the second conductive member 33 and the substrate 31 are integrally formed through injection molding, which can improve connecting efficiency and connecting stability of the second conductive member 33 and the substrate 31.

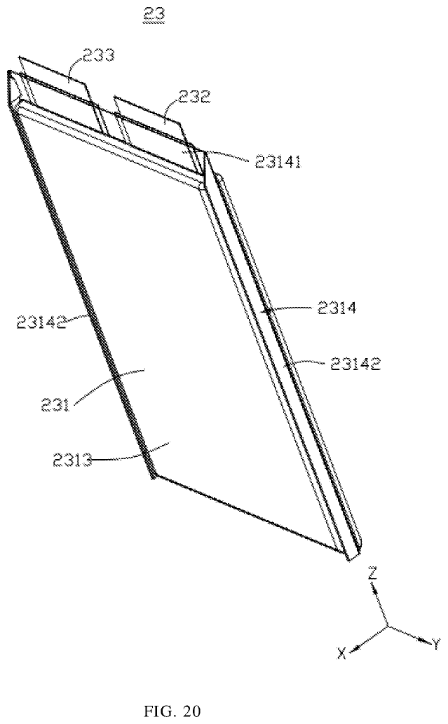

As shown in FIG. 20, the third battery cell 23 further includes a third shell 231, a third electrode assembly (not shown in the figure), and a seventh conductive plate 233. The third electrode assembly is disposed in the third shell 231. Both the third conductive plate 232 and the seventh conductive plate 233 are connected to the third electrode assembly and stretch out of the third shell 231.

One of the third conductive plate 232 and the seventh conductive plate 233 serves as a positive conductive plate, and the other one of the third conductive plate 232 and the seventh conductive plate 233 serves as a negative conductive plate. Optionally, the third conductive plate 232 serves as the positive conductive plate, and the seventh conductive plate 233 serves as the negative conductive plate.

In an embodiment, the third electrode assembly has the same structure as the first electrode assembly 212, which will not be described in detail in this application.

In an embodiment, the third shell 231 includes a third body portion 2313 and a third seal edge portion 2314. The third seal edge portion 2314 is connected to the third body portion 2313 and extends from the third body portion 2313. The third electrode assembly is disposed in the third body portion 2313. The third conductive plate 232 and the seventh conductive plate 233 stretch out of the third seal edge portion 2314.

In an embodiment, the third seal edge portion 2314 includes a third side seal edge 23142 and a third top seal edge 23141 that are mutually connected. The third conductive plate 232 and the seventh conductive plate 233 stretch out of the third top seal edge 23141. The third top seal edge 23141 is located on an end portion of the third body portion 2313 in the third direction Z, and the third side seal edge 23142 is located on an end portion of the third body portion 2313 in the second direction Y.

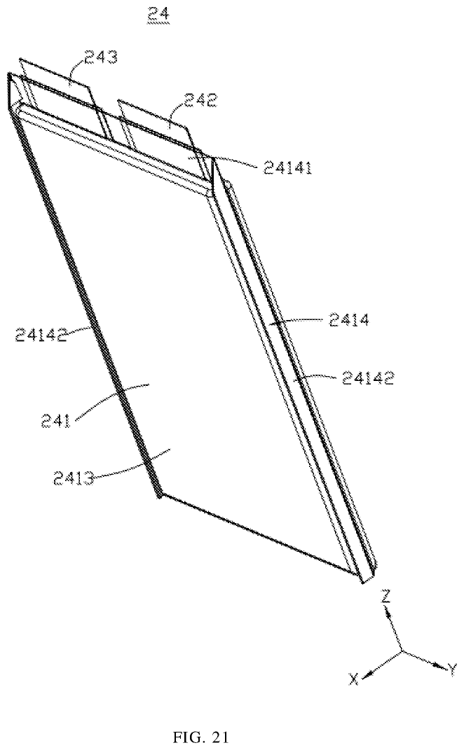

As shown in FIG. 21, the fourth battery cell 24 further includes a fourth shell 241, a fourth electrode assembly (not shown in the figure), and an eighth conductive plate 243. The fourth electrode assembly is disposed in the fourth shell 241. Both the fourth conductive plate 242 and the eighth conductive plate 243 are connected to the fourth electrode assembly and stretch out of the fourth shell 241.

One of the fourth conductive plate 242 and the eighth conductive plate 243 serves as a positive conductive plate, and the other one of the fourth conductive plate 242 and the eighth conductive plate 243 serves as a negative conductive plate. Optionally, the fourth conductive plate 242 serves as the negative conductive plate, and the eighth conductive plate 243 serves as the positive conductive plate.

In an embodiment, the fourth electrode assembly has the same structure as the first electrode assembly 212, which will not be described in detail in this application.

In an embodiment, the fourth shell 241 includes a fourth body portion 2413 and a fourth seal edge portion 2414. The fourth seal edge portion 2414 is connected to the fourth body portion 2413 and extends from the fourth body portion 2413. The fourth electrode assembly is disposed in the fourth body portion 2413. The fourth conductive plate 242 and the eighth conductive plate 243 stretch out of the fourth seal edge portion 2414.

In an embodiment, the fourth seal edge portion 2414 includes a fourth side seal edge 24142 and a fourth top seal edge 24141 that are mutually connected. The fourth conductive plate 242 and the eighth conductive plate 243 stretch out of the fourth top seal edge 24141. The fourth top seal edge 24141 is located on an end portion of the fourth body portion 2413 in the third direction Z, and the fourth side seal edge 24142 is located on an end portion of the fourth body portion 2413 in the second direction Y.

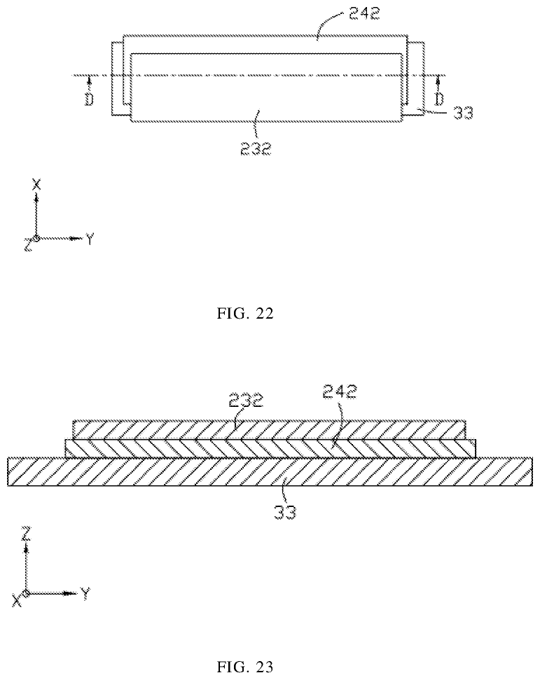

As shown in FIG. 22 and FIG. 23, in an embodiment, in the third direction Z, the fourth conductive plate 242 is stacked between the third conductive plate 232 and the second conductive member 33 and connected to the third conductive plate 232 and the second conductive member 33.

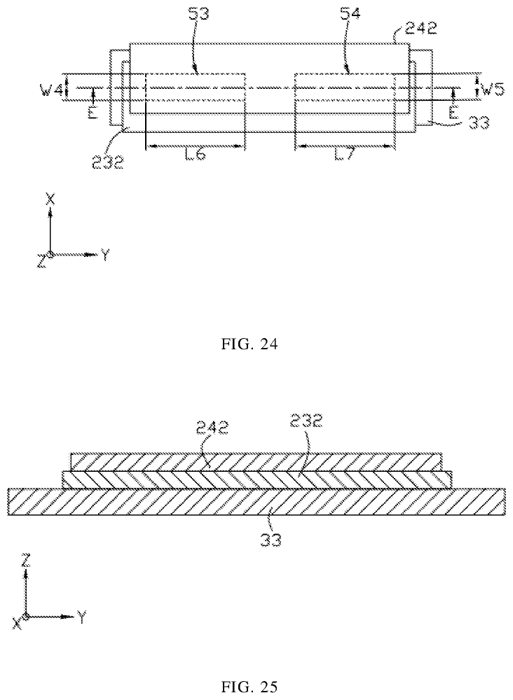

As shown in FIG. 24 and FIG. 25, in an embodiment, in the third direction Z, the third conductive plate 232 is stacked between the fourth conductive plate 242 and the second conductive member 33 and connected to the fourth conductive plate 242 and the second conductive member 33.

Exemplarily, a further illustration is made below by taking the third conductive plate 232 being stacked between the fourth conductive plate 242 and the second conductive member 33 in the third direction Z as an example.

Still referring to FIG. 19, in an embodiment, the substrate 31 is provided with a third through hole 313 and a fourth through hole 314 running therethrough. The third through hole 313 and the fourth through hole 314 are respectively located on two sides of the second conductive member 33 in the first direction X. A portion of the fourth conductive plate 242 runs through the fourth through hole 314, and is bent towards the second conductive member 33 and connected to the second conductive member 33. A portion of the third conductive plate 232 runs through the third through hole 313, and is bent towards the second conductive member 33 and connected to the fourth conductive plate 242.

As shown in FIG. 24, in an embodiment, the third region 53 is disposed in the second direction Y. A length of the third region 53 in the second direction Y is a sixth length L6, and a length of the third region 53 in the first direction X is a fourth dimension W4, where L6>W4. The third region 53 can utilize spaces of the third conductive plate 232 and the fourth conductive plate 242 in the second direction Y and a space of the second conductive member 33 in the second direction Y, so that space utilization rates of the third conductive plate 232 and the fourth conductive plate 242 are increased, which is conducive for the third conductive plate 232 and the fourth conductive plate 242 to dissipate heat, thereby increasing heat dissipating rates of the third battery cell 23 and the fourth battery cell 24, and reducing the impact of the length of the third region 53 in the first direction X on the size of the second conductive member 33.

In an embodiment, the fourth region 54 is disposed in the second direction Y. A length of the fourth region 54 in the second direction Y is a seventh length L7, and a length of the fourth region 54 in the first direction X is a fifth dimension W5, where L7>W5. The fourth region 54 can utilize the spaces of the third conductive plate 232 and the fourth conductive plate 242 in the second direction Y, so that the space utilization rates of the third conductive plate 232 and the fourth conductive plate 242 are increased, which is conducive for the third conductive plate 232 and the fourth conductive plate 242 to dissipate heat, thereby increasing the heat dissipating rates of the third battery cell 23 and the fourth battery cell 24. In an embodiment, the sixth length L6 is equal to the seventh length L7.

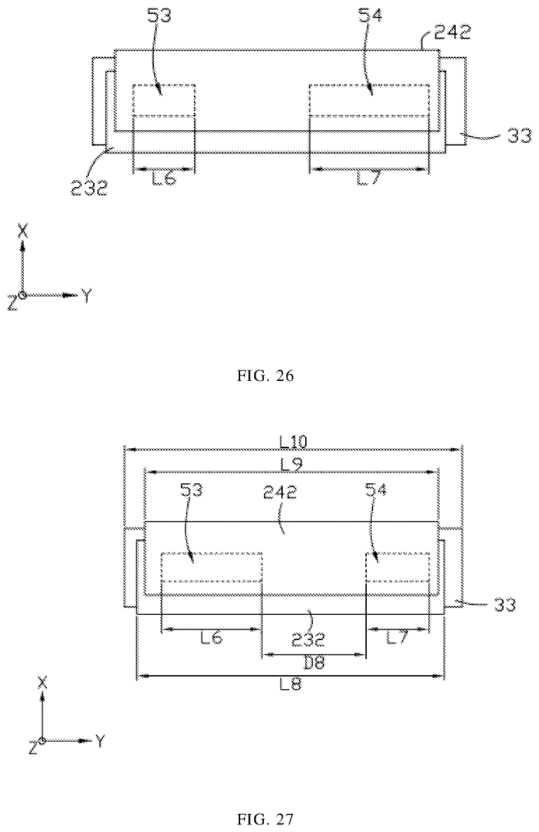

As shown in FIG. 26, in an embodiment, the sixth length L6 is not equal to the seventh length L7. In an embodiment, the sixth length L6 is less than the seventh length L7.

As shown in FIG. 27, in an embodiment, the sixth length L6 is greater than the seventh length L7.

In an embodiment, in the second direction Y, a length of the third conductive plate 232 is an eighth length L8, where (L6+L7)<L8. In an embodiment, 0.50≤(L6+L7)/L8≤0.95, which is conducive for the third region 53 and the fourth region 54 to utilize the space of the third conductive plate 232 in the second direction Y, thereby increasing the space utilization rate of the third conductive plate 232; and a connecting area of the third conductive plate 232 and the fourth conductive plate 242 is increased, which is conducive for the third conductive plate 232 and the fourth conductive plate 242 to dissipate heat, thereby increasing the heat dissipating rates of the third battery cell 23 and the fourth battery cell 24.

In an embodiment, 0.75≤(L6+L7)/L8≤0.95, so that the space utilization rate of the third conductive plate 232 can be further increased, and the connecting area of the third conductive plate 232 and the fourth conductive plate 242 is increased, which is conducive for the third conductive plate 232 and the fourth conductive plate 242 to dissipate heat, thereby increasing the heat dissipating rates of the third battery cell 23 and the fourth battery cell 24.

In an embodiment, a value of (L6+L7)/L8 is any one of 0.50, 0.55, 0.60, 0.65, 0.70, 0.75, 0.80, 0.85, 0.90, and 0.95. In an embodiment, the value of (L6+L7)/L8 is a result correct to two decimal places.

In an embodiment, in the second direction Y, a length of the fourth conductive plate 242 is a ninth length L9, where (L6+L7)<L9. In an embodiment, 0.50≤(L6+L7)/L9≤0.95, which is conducive for the third region 53 and the fourth region 54 to utilize the space of the fourth conductive plate 242 in the second direction Y, thereby increasing the space utilization rate of the fourth conductive plate 242, and the connecting area of the third conductive plate 232 and the fourth conductive plate 242 is increased, which is conducive for the third conductive plate 232 and the fourth conductive plate 242 to dissipate heat, thereby increasing the heat dissipating rates of the third battery cell 23 and the fourth battery cell 24.

In an embodiment, 0.75≤(L6+L7)/L9≤0.95, so that the space utilization rate of the fourth conductive plate 242 can be further increased, and the connecting area of the third conductive plate 232 and the fourth conductive plate 242 is increased, which is conducive for the third conductive plate 232 and the fourth conductive plate 242 to dissipate heat, thereby increasing the heat dissipating rates of the third battery cell 23 and the fourth battery cell 24.

In an embodiment, a value of (L6+L7)/L9 is any one of 0.50, 0.55, 0.60, 0.65, 0.70, 0.75, 0.80, 0.85, 0.90, and 0.95. In an embodiment, the value of (L6+L7)/L9 is a result correct to two decimal places.

In an embodiment, in the second direction Y, a length of the second conductive member 33 is a tenth length L10, where L6≤L10. In an embodiment, 0.20≤L6/L10≤1, which is conducive for the third region 53 to utilize the space of the second conductive member 33 in the second direction Y, thereby increasing a space utilization rate of the second conductive member 33, and a connecting area of the third conductive plate 232, the fourth conductive plate 242 and the second conductive member 33 is increased, which is conducive for the third conductive plate 232 and the fourth conductive plate 242 to dissipate heat through the second conductive member 33, thereby increasing the heat dissipating rates of the third battery cell 23 and the fourth battery cell 24.

In an embodiment, 0.60≤L6/L10≤1, so that the space utilization rate of the second conductive member 33 can be further increased, and the connecting area of the third conductive plate 232, the fourth conductive plate 242 and the second conductive member 33 is increased, which is conducive for the third conductive plate 232 and the fourth conductive plate 242 to dissipate heat through the second conductive member 33, thereby increasing the heat dissipating rates of the third battery cell 23 and the fourth battery cell 24.

In an embodiment, a value of L6/L10 is any one of 0.20, 0.25, 0.30, 0.35, 0.40, 0.45, 0.50, 0.55, 0.60, 0.65, 0.70, 0.75, 0.80, 0.85, 0.90, 0.95, and 1.00. In an embodiment, the value of L6/L10 is a result correct to two decimal places.

In an embodiment, in the second direction Y, a distance between the third region 53 and the fourth region 54 is an eighth distance D8, where 0<D8≤2 mm, which can not only provide enough travel time for the welding machine to adjust a welding parameter, but also reduce the impact of the eighth distance D8 on the lengths of the third conductive plate 232 and the fourth conductive plate 242 in the second direction Y, thereby increasing the space utilization rate of the third conductive plate 232 and the space utilization rate of the fourth conductive plate 242.

In an embodiment, 0.5 mm≤D8≤1.5 mm.

In an embodiment, a value of D8 is any one of 0.1 mm, 0.2 mm, 0.3 mm, 0.4 mm, 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9, and 2 mm.

In an embodiment, in the third direction Z, a projection of the third region 53 at least partially overlaps a projection of the second conductive member 33, which is conducive for the third conductive plate 232 and the fourth conductive plate 242 to be welded to the second conductive member 33 through the third region 53, and the welding power is adjusted according to a thickness of the third conductive plate 232 and a thickness of the fourth conductive plate 242, so as to improve the effect of the third region 53 being connected to the second conductive member 33 through welding.

In an embodiment, in the third direction Z, a projection of the fourth region 54 at least partially overlaps a projection of the second conductive member 33. When the fourth region 54 shakes relative to the second conductive member 33, the second conductive member 33 can make contact with the fourth region 54 and provide supporting force for the fourth region 54 to reduce the impact of shaking of the fourth region 54 on the third region 53 being connected to the second conductive member 33, thereby improving the seismic performance of the electrochemical apparatus 100.

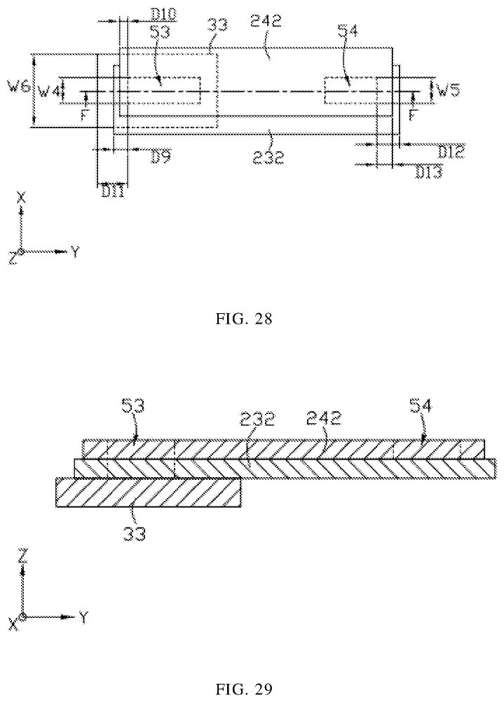

As shown in FIG. 28 and FIG. 29, in an embodiment, in the third direction Z, the projection of the fourth region 54 is separated from the projection of the second conductive member 33, which is conducive for the third conductive plate 232 and the fourth conductive plate 242 to be connected through welding through the fourth region 54, and by adjusting the welding power according to the thickness of the upper-layer conductive plate 252, the welding effect of the fourth region 54 can be improved, and electric energy is saved. Furthermore, the length of the second conductive member 33 in the second direction Y can further be reduced, and a manufacturing cost of the second conductive member 33 is saved, thereby saving the manufacturing cost of the electrochemical apparatus 100. Moreover, due to the reduction of the length of the second conductive member 33, an area of the second conductive member being connected to the substrate 31 can be reduced, and when the second conductive member 33 is heated up, the risk of deformation of the substrate 31 caused by uneven temperature distribution can be reduced.

Exemplarily, a further illustration is made below by taking the projection of the fourth region 54 being separated from the projection of the second conductive member 33 in the third direction Z as an example.

In an embodiment, in the second direction Y, a minimum distance between the third region 53 and an end portion of the third conductive plate 232 is a ninth distance D9, a minimum distance between the third region 53 and an end portion of the fourth conductive plate 242 is a tenth distance D10, and a minimum distance between the third region 53 and an end portion of the second conductive member 33 is an eleventh distance D11. A minimum value among the ninth distance D9, the tenth distance D10 and the eleventh distance D11 ranges from 0 mm to 2 mm, which is conducive to increasing the space utilization rate of the third conductive plate 232, the space utilization rate of the fourth conductive plate 242, and the space utilization rate of the second conductive member 33.

In an embodiment, the minimum value among the ninth distance D9, the tenth distance D10 and the eleventh distance D11 is any one of 0 mm, 0.2 mm, 0.4 mm, 0.6 mm, 0.8 mm, 1 mm, 1.2 mm, 1.4 mm, 1.6 mm, 1.8 mm, and 2 mm.

In this application, in the second direction Y, the third region 53 is provided with two opposite end portions, and the third conductive plate 232 is provided with two opposite end portions. There are two distances between one end of the third region 53 and the two end portions of the third conductive plate 232, and there are two distances between the other end of the third region 53 and the two end portions of the third conductive plate 232. That is, there are a total of four distances between the two end portions of the third region 53 and the two end portions of the third conductive plate 232. The ninth distance D9 is the minimum distance among the four distances.

In this application, in the second direction Y, the third region 53 is provided with two opposite end portions, and the fourth conductive plate 242 is provided with two opposite end portions. There are two distances between one end of the third region 53 and the two end portions of the fourth conductive plate 242, and there are two distances between the other end of the third region 53 and the two end portions of the fourth conductive plate 242. That is, there are a total of four distances between the two end portions of the third region 53 and the two end portions of the fourth conductive plate 242. The tenth distance D10 is the minimum distance among the four distances.

In this application, in the second direction Y, the third region 53 is provided with two opposite end portions, and the second conductive member 33 is provided with two opposite end portions. There are two distances between one end of the third region 53 and the two end portions of the second conductive member 33, and there are two distances between the other end of the third region 53 and the two end portions of the second conductive member 33. That is, there are a total of four distances between the two end portions of the third region 53 and the two end portions of the second conductive member 33. The eleventh distance D11 is the minimum distance among the four distances.

In an embodiment, in the second direction Y, a minimum distance between the fourth region 54 and an end portion of the third conductive plate 232 is a twelfth distance D12, and a minimum distance between the fourth region 54 and an end portion of the fourth conductive plate 242 is a thirteenth distance D13. A minimum value in the twelfth distance D12 and the thirteenth distance D13 ranges from 0 mm to 2 mm, which is conducive to increasing the space utilization rate of the third conductive plate 232 and the space utilization rate of the fourth conductive plate 242.

In an embodiment, the minimum value in the twelfth distance D12 and the thirteenth distance D13 is any one of 0 mm, 0.2 mm, 0.4 mm, 0.6 mm, 0.8 mm, 1 mm, 1.2 mm, 1.4 mm, 1.6 mm, 1.8 mm, and 2 mm.

In this application, in the second direction Y, the fourth region 54 is provided with two opposite end portions, and the third conductive plate 232 is provided with two opposite end portions. There are two distances between one end of the fourth region 54 and the two end portions of the third conductive plate 232, and there are two distances between the other end of the fourth region 54 and the two end portions of the third conductive plate 232. That is, there are a total of four distances between the two end portions of the fourth region 54 and the two end portions of the third conductive plate 232. The twelfth distance D12 is the minimum distance among the four distances.

In this application, in the second direction Y, the fourth region 54 is provided with two opposite end portions, and the fourth conductive plate 242 is provided with two opposite end portions. There are two distances between one end of the fourth region 54 and the two end portions of the fourth conductive plate 242, and there are two distances between the other end of the fourth region 54 and the two end portions of the fourth conductive plate 242. That is, there are a total of four distances between the two end portions of the fourth region 54 and the two end portions of the fourth conductive plate 242. The thirteenth distance D13 is the minimum distance among the four distances.

In an embodiment, in the first direction X, a length of the third region 53 is a fourth dimension W4, and a length of the fourth region 54 is a fifth dimension W5, where 0.8≤W4/W5≤1.2, which is conducive for the welding machine to continuously weld the third region 53 and the fourth region 54 to reduce a parameter difference when the welding machine welds the third region 53 and the fourth region 54 and to improve the consistency of the welding effects. In an embodiment, a value of W4/W5 is any one of 0.8, 0.9, 1, 1.1, and 1.2.

In an embodiment, the fourth dimension W4 is not equal to the fifth dimension W5. In an embodiment, the fourth dimension W4 is greater than the fifth dimension W5. In an embodiment, the fourth dimension W4 is less than the fifth dimension W5.

In an embodiment, in the first direction X, a length of the second conductive member 33 is a sixth dimension W6, where W4<W6. In an embodiment, 0.50≤W4/W6≤0.95, which is conducive to increasing the space utilization rate of the second conductive member 33, and improving stability of the third region 53 being connected to the second conductive member 33. In an embodiment, 0.70≤W4/W6≤0.95, which can further increase the space utilization rate of the second conductive member 33, and improve the stability of the third region 53 being connected to the second conductive member 33.

In an embodiment, a value of W4/W6 is any one of 0.50, 0.55, 0.60, 0.65, 0.70, 0.75, 0.80, 0.85, 0.90, and 0.95. In an embodiment, the value of W4/W6 is a result correct to two decimal places.

Still referring to FIG. 6 and FIG. 7, in an embodiment, the first battery cell 21, the second battery cell 22, the third battery cell 23, and the fourth battery cell 24 are stacked in the first direction X, and the first shell 211, the second shell 221, the third shell 231, and the fourth shell 241 are stacked in the first direction X.

In an embodiment, the first battery cell 21, the second battery cell 22, the third battery cell 23, and the fourth battery cell 24 are stacked in sequence in the first direction X and electrically connected in sequence. In other embodiments, in the first direction X, the first battery cell 21 and the second battery cell 22 are stacked in sequence and electrically connected, the third battery cell 23 and the fourth battery cell 24 are stacked in sequence and electrically connected, and the second battery cell 22 is separated from the third battery cell 23 (not shown in the figure).

Exemplarily, a further illustration is made below by taking the first battery cell 21, the second battery cell 22, the third battery cell 23, and the fourth battery cell 24 being stacked in sequence in the first direction X and electrically connected as an example.

The first battery cell 21 and the second battery cell 22 are electrically connected through the first conductive plate 213 being connected to the second conductive plate 222, the second battery cell 22 and the third battery cell 23 are electrically connected through the sixth conductive plate 223 being connected to the seventh conductive plate 233, and the third battery cell 23 and the fourth battery cell 24 are electrically connected through the third conductive plate 232 being connected to the fourth conductive plate 242, so that the first battery cell 21, the second battery cell 22, the third battery cell 23, and the fourth battery cell 24 can be tightly arrayed, and through a space inside the electrochemical apparatus 100, the volume energy density in the electrochemical apparatus 100 is increased. In the first direction X, the projection of the first conductive plate 213, the projection of the second conductive plate 222, the projection of the third conductive plate 232, and the projection of the fourth conductive plate 242 at least partially overlap, the projection of the fifth conductive plate 214, the projection of the sixth conductive plate 223, the projection of the seventh conductive plate 233, and the projection of the eighth conductive plate 243 at least partially overlap, and the projection of the first conductive member 32 and the projection of the second conductive member 33 at least partially overlap.

In an embodiment, in the second direction Y, a connected region of the sixth conductive plate 223 and the seventh conductive plate 233 is at least partially separated from a connected region of the first conductive plate 213 and the second conductive plate 222, and the connected region of the sixth conductive plate 223 and the seventh conductive plate 233 is at least partially separated from a connected region of the third conductive plate 232 and the fourth conductive plate 242, which are conducive for a surface of the substrate 31 to evenly dissipate heat to reduce a risk of local temperature aggregation of the surface of the substrate 31, as well as conducive for the first conductive plate 213, the second conductive plate 222, the third conductive plate 232, and the fourth conductive plate 242 to evenly dissipate heat to reduce temperature differences between the first battery cell 21, the second battery cell 22, the third battery cell 23, and the fourth battery cell 24, thereby reducing the impact of the temperature differences on the charge and discharge performance of the battery cell assembly 20.

As shown in FIG. 28, in an embodiment, in the second direction Y, a projection of the third region 53 overlaps a projection of the fourth region 54, which is conducive for the welding machine to continuously weld the third region 53 and the fourth region 54 to reduce a parameter difference when the welding machine welds the third region 53 and the fourth region 54 and to improve consistency of welding effects.

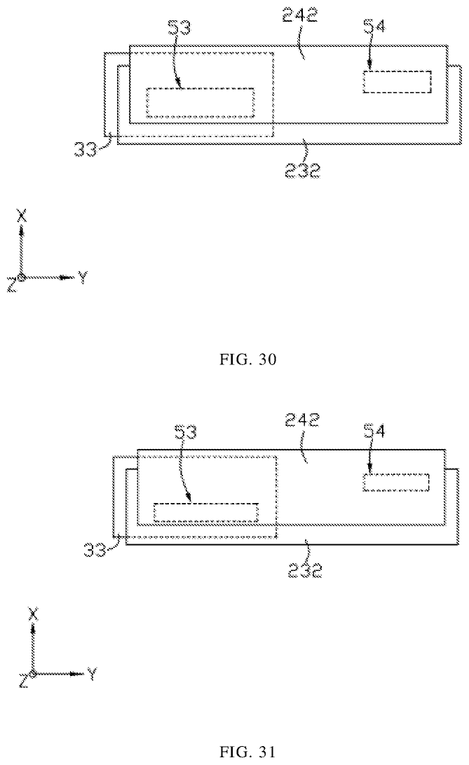

As shown in FIG. 30, in an embodiment, in the second direction Y, the projection of the third region 53 partially overlaps the projection of the fourth region 54, which is conducive for the third conductive plate 232 and the fourth conductive plate 242 to evenly dissipate heat, so as to reduce a temperature difference between the third battery cell 23 and the fourth battery cell 24 and reduce the impact of the temperature difference on the charge and discharge performance of the battery cell assembly 20.

As shown in FIG. 31, in an embodiment, in the second direction Y, the projection of the third region 53 is separated from the projection of the fourth region 54, which is conducive for the third conductive plate 232 and the fourth conductive plate 242 to evenly dissipate heat, so as to reduce the temperature difference between the third battery cell 23 and the fourth battery cell 24 and reduce the impact of the temperature difference on the charge and discharge performance of the battery cell assembly 20.

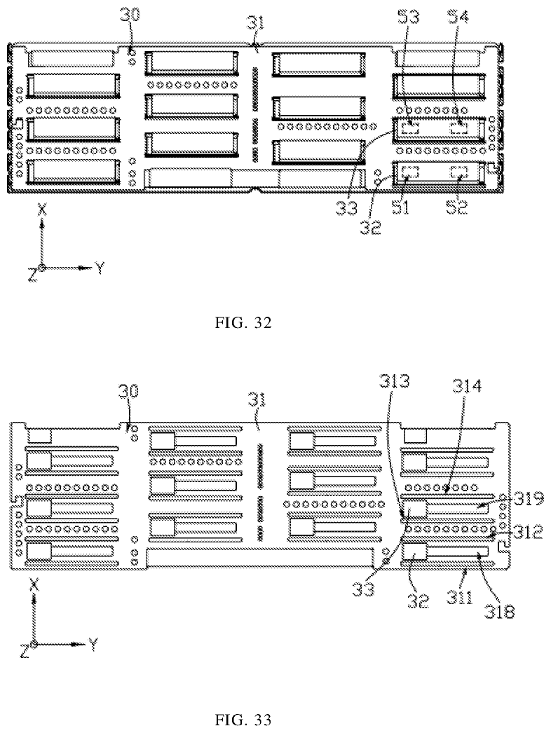

As shown in FIG. 32 and FIG. 33, in an embodiment, in the first direction X, a projection of the first region 51 at least partially overlaps a projection of the third region 53, and a projection of the second region 52 at least partially overlaps a projection of the fourth region 54. In the first direction X, the first region 51 and the third region 53 are arrayed, and the second region 52 and the fourth region 54 are arrayed, which is conducive to reducing the complexity degree of the welding operation and improving consistency of welding parameters of the welding machine in different regions, thereby improving the welding quality and effect.

In an embodiment, in the first direction X, the first conductive member 32 and the second conductive member 33 are arrayed, and the projection of the first conductive member 32 at least partially overlaps the projection of the second conductive member 33, which is conducive to reducing the complexity of the first conductive member 32 and the second conductive member 33 being connected to the substrate 31, improving the assembly efficiency of the first conductive member 32 and the second conductive member 33 being connected to the substrate 31, and saving the assembly cost of the electrochemical apparatus 100.

In an embodiment, an eighth through hole 318 is further provided in the substrate 31. The eighth through hole 318 is provided between the first through hole 311 and the second through hole 312. The eighth through hole 318 can reduce the weight of the substrate 31, which in turn reduces the weights of the adapter plate 30 and the electrochemical apparatus 100. The eighth through hole can further provide a heat dissipating channel, which is conducive for the first conductive member 32 to dissipate heat.

In an embodiment, a ninth through hole 319 is further provided in the substrate 31. The ninth through hole 319 is provided between the third through hole 313 and the fourth through hole 314. The ninth through hole 319 can reduce the weight of the substrate 31, which in turn reduces the weights of the adapter plate 30 and the electrochemical apparatus 100. The ninth through hole can further provide a heat dissipating channel, which is conducive for the second conductive member 33 to dissipate heat.

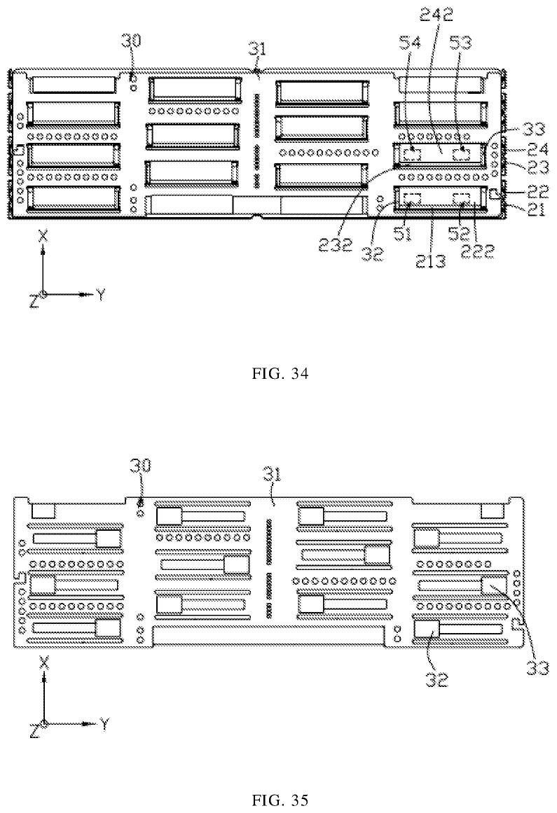

As shown in FIG. 34 and FIG. 35, in an embodiment, in the first direction X, the projection of the first region 51 at least partially overlaps the projection of the fourth region 54, and the projection of the second region 52 at least partially overlaps the projection of the third region 53. In the first direction X, the first region 51 and the third region 53 are staggered, and the second region 52 and the fourth region 54 are staggered. The welding regions of the same type being staggered in the first direction X is conducive for the first conductive plate 213, the second conductive plate 222, the third conductive plate 232, and the fourth conductive plate 242 to evenly dissipate heat to reduce the risk of local temperature aggregation, as well as conducive to reducing the temperature differences between the first battery cell 21, the second battery cell 22, the third battery cell 23, and the fourth battery cell 24, thereby reducing the impact of the temperature differences on the charge and discharge performance of the battery cell assembly 20.

In an embodiment, in the first direction X, the first conductive member 32 and the second conductive member 33 are staggered, which is conducive for the surface of the substrate 31 to dissipate heat to reduce the risk of local temperature aggregation of the surface of the substrate 31, as well as conducive for the first conductive plate 213, the second conductive plate 222, the third conductive plate 232, and the fourth conducive plate 242 to evenly dissipate heat to reduce the temperature differences between the first battery cell 21, the second battery cell 22, the third battery cell 23, and the fourth battery cell 24, thereby reducing the impact of the temperature differences on the charge and discharge performance of the battery cell assembly 20. The first conductive member 32 and the second conductive member 33 being staggered in the first direction X indicates that after the first conductive member 32 and the second conductive member 33 are disposed on the substrate 31, in the second direction Y, the first conductive member 32 is close to one side edge of the substrate 31, and the second conductive member 33 is close to the other opposite side edge of the substrate 31.

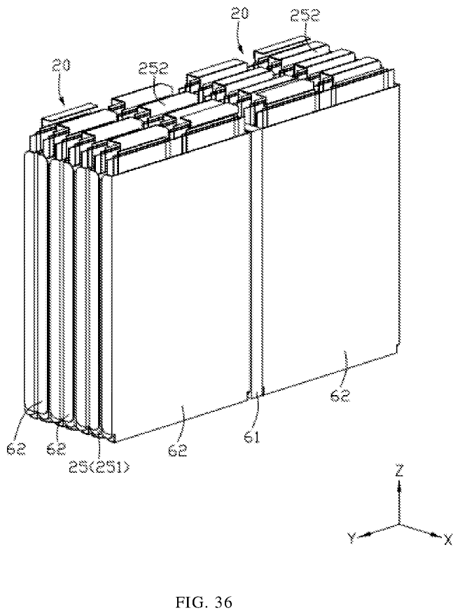

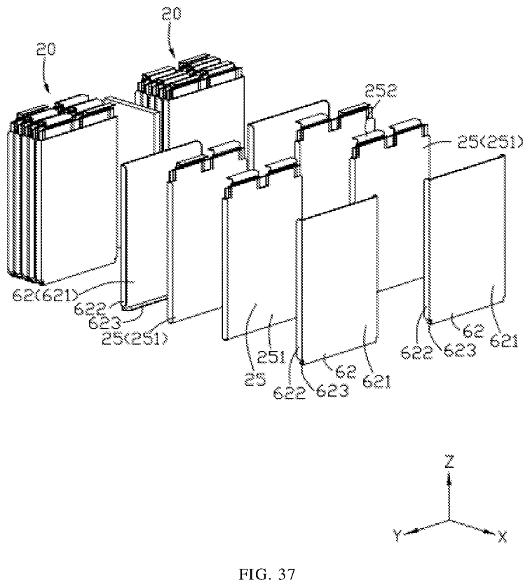

Referring in conjunction to FIG. 6, FIG. 7, FIG. 36, and FIG. 37, in an embodiment, in addition to including the first battery cell 21, the second battery cell 22, the third battery cell 23, and the fourth battery cell 24, the battery cell assembly 20 further includes other battery cell units 25. For ease of understanding and describing, a further illustration is made below by taking the battery cell assembly 20 including a plurality of battery cell units 25, and each battery cell unit 25 including a battery cell shell 251 and a conductive plate 252 as an example.

In an embodiment, the manner in which the other battery cell units 25 are electrically connected to each other includes at least one of the connecting manners of the first conductive plate 213, the second conductive plate 222, and the first conductive member 32 according to the embodiments.

In an embodiment, the manner in which the other battery cell units 25 are electrically connected to each other includes at least one of the connecting manners of the third conductive plate 232, the fourth conductive plate 242, and the second conductive member 33 according to the embodiments.

In an embodiment, the adapter plate 30 includes a plurality of conductive members 34, and the plurality of conductive members 34 are disposed on the substrate 31 and exposed to a side of the substrate 31 facing away from the battery cell shells 251, where the plurality of conductive members 34 include a first conductive member 32 and a second conductive member 33.

In an embodiment, the substrate 31 is provided with a plurality of through holes 315, and the plurality of through holes 315 allow the plurality of conductive plates 252 to pass through to connect the plurality of conductive members 34. The plurality of through holes 315 include a first through hole 311, a second through hole 312, a third through hole 313, and a fourth through hole 314.

In an embodiment, there are a plurality of battery cell assemblies 20, and the plurality of battery cell assemblies 20 are arrayed in the second direction Y. In an embodiment, there are two battery cell assemblies 20. In other embodiments, there may also be three, four or more battery cell assemblies 20 (not shown in the figure).

Exemplarily, a further illustration is made below by taking there being two battery cell assemblies 20 as an example.

In an embodiment, the electrochemical apparatus 100 further includes a first structural member 61. The first structural member 61 is disposed between the two battery cell assemblies 20, and the first structural member 61 is connected to the two battery cell assemblies 20. When viewed in the second direction Y, projections of a plurality of battery cell units 25 overlap a projection of the first structural member 61. The first structural member 61 is connected to the plurality of battery cell units 25, so that heat on the plurality of battery cells 25 can be partially transferred to the first structural member 61, which is conducive to reducing temperature differences between the battery cell units 25 in the battery cell assemblies 20. Optionally, the projections of all the battery cell units 25 overlap the projection of the first structural member 61.

In an embodiment, an outer surface of the first structural member 61 includes a metal material with a good heat conducting property, which is conducive to heat dissipation. In an embodiment, the first structural member 61 is made of a metal material with a good heat conducting property, such as aluminum. In an embodiment, the first structural member 61 is formed at a time through casting.

In an embodiment, the battery cell assembly 20 further includes a second structural member 62. The second structural member 62 is connected to a battery cell shell 251 of a battery cell unit 25 and the first structural member 61. In the first direction X, a projection of the second structural member 62 overlaps a projection of the battery cell shell 251, and in the second direction Y, a projection of the second structural member 62 overlaps a projection of the first structural member 61. Part of heat on the battery cell unit 25 may be transferred to the second structural member 62 through the battery cell shell 251, part of heat on the second structural member 62 may be transferred to the first structural member 61, and the second structural member 62 is conducive to improving the heat dissipating efficiency of the battery cell unit 25.

In an embodiment, there are a plurality of second structural members 62, and each of the second structural members 62 is connected to a corresponding battery cell shell 251 and a first structural member 61, which may improve the heat dissipating efficiency of a battery cell assembly 20.

In an embodiment, a second structural member 62 includes a first bottom plate 621, a first side wall 622, and a second side wall 623, The first side wall 622 and the second side wall 623 are disposed on the first bottom plate 621 and located on the same side of the first bottom plate 621.

Taking the mutually connected second structural member 62 and battery cell unit 25 as an example, in the first direction X, a projection of the battery cell shell 251 is located in a projection of the first bottom plate 621, in the second direction Y, a projection of the battery cell shell 251 overlaps a projection of the first side wall 622, and in the third direction Z, a projection of the battery cell shell 251 overlaps a projection of the second side wall 623. The second structural member 62 wraps a portion of the battery cell shell 251, which may improve the heat transfer efficiency between the second structural member 62 and the battery cell unit 25.

In an embodiment, there are two first side walls 622, and the two first side walls 622 are respectively located on two sides of a battery cell shell 251 in the second direction Y. In an embodiment, the two first side walls 622 are respectively opposite to and connected to end portions of the battery cell shell 251 in the second direction Y. In an embodiment, a second side wall 623 is opposite to and connected to a bottom of the battery cell shell 251 in the third direction Z, where the bottom of the battery cell shell 251 and a conductive plate 252 are respectively located at two opposite ends of the battery cell shell 251 in the third direction Z.

In an embodiment, each second structural member 62 and the corresponding battery cell unit 25 form a heat dissipating assembly, and the plurality of heat dissipating assemblies are stacked in the first direction X. Optionally, in every two adjacent heat dissipating assemblies, the two corresponding battery cell units 25 are adjacently disposed, and the two corresponding second structural members 62 are respectively located on the two sides of the two adjacent battery cell units 25.

In an embodiment, an outer surface of a second structural member 62 includes a metal material, which is conducive to heat dissipation. In an embodiment, a second structural member 62 is made of a material with a good heat conducting property, such as metal aluminum, metal copper, copper alloy, and iron alloy. In an embodiment, a second structural member 62 is formed at a time through casting. In an embodiment, a second structural member 62 is formed by bending a profile.

Referring to FIG. 2, in an embodiment, the electrochemical apparatus 100 further includes a first insulation member 81. The first insulation member 81 is disposed between the battery cell assemblies 20 and the fifth wall 15 in the third direction Z. The first insulation member 81 is connected to the first wall 11, the second wall 12, the third wall 13, and the fourth wall 14. A first space 17 for accommodating the battery cell assemblies 20 and the adapter plate 30 is defined by the first insulation member 81, the first wall 11, the second wall 12, the third wall 13, the fourth wall 14, and the sixth wall 16. A second space 18 for accommodating the circuit board 40 is defined by the first insulation member 81 and the fifth wall 15. The first space 17 is separated from the second space 18, so that the heat transfer efficiency between the first space 17 and the second space 18 can be reduced, thereby reducing the impact of a temperature rise of the battery cell assemblies 20 on the circuit board 40. In this application, the first space 17 being isolated from the second space 18 indicates that the first space 17 does not communicate with the second space 18.

The two battery cell assemblies 20 are electrically connected to each other and both connected to the circuit board 40. A plurality of battery cells in the battery cell assembly 20 are electrically connected through a plurality of conductive members 34. In the battery cell assembly 20, two conductive plates 252 that are not connected to other conductive plates 252 form a main positive conductive plate and a main negative conductive plate of the battery cell assembly 20. The main positive conductive plate and the main negative conductive plate are electrically connected to the circuit board 40. The battery cell assembly 20 is charged and discharged through the main positive conductive plate and the main negative conductive plate.

In an embodiment, the electrochemical apparatus 100 further includes a first terminal 71 and a second terminal 72. A portion of the first terminal 71 is located in the first space 17 and connected to the main positive conductive plate, and a portion of the first terminal 71 is located in the second space 18 and connected to the circuit board 40. A portion of the second terminal 72 is located in the first space 17 and connected to the main negative conductive plate, and a portion of the second terminal 72 is located in the second space 18 and connected to the circuit board 40. The first terminal 71 and the second terminal 72 make the main positive conductive plate and the main negative conductive plate electrically connected to the circuit board 40.

In an embodiment, a portion of the first terminal 71 is embedded in the substrate 31. In an embodiment, the first terminal 71 and the substrate 31 are integrally formed through injection molding, which can improve the connecting efficiency and connecting stability of the first terminal 71 and the substrate 31. In an embodiment, a portion of the second terminal 18 is embedded in the substrate 31. In an embodiment, the second terminal 72 and the substrate 31 are integrally formed through injection molding, which can improve the connecting efficiency and connecting stability of the second terminal 72 and the substrate 31.

In an embodiment, the electrochemical apparatus 100 further includes a wiring harness 73 and a connecting member 74. The connecting member 74 is disposed on a side of the substrate 31 facing away from a battery cell shell 251. The connecting member 74 is electrically connected to a plurality of conductive members 34, and the connecting member 74 is electrically connected to a plurality of conductive plates 252 by being electrically connected to the plurality of conductive members 34. A portion of the wiring harness 73 is located in the first space 17 and connected to the connecting member 74, and a portion of the wiring harness 73 is located in the second space 18 and connected to the circuit board 40, so that the circuit board 40 is electrically connected to a plurality of battery cell units 25 through the wiring harness 73 and terminals of the wiring harness 73, and the circuit board 40 can acquire information of the plurality of battery cell units 25, such as voltage information.

In an embodiment, a portion of the connecting member 74 is embedded in the substrate 31. In an embodiment, the connecting member 74 and the substrate 31 are integrally formed through injection molding, which can improve the connecting efficiency and connecting stability of the connecting member 74 and the substrate 31.

In an embodiment, the connecting member 74 includes a connector. The wiring harness 73 is plugged into the connector in a pluggable manner, which can improve the disassembly and assembly efficiency of the wiring harness 73 and the connecting member 74, and dismounting and maintenance are facilitated. In an embodiment, the wiring harness 73 is plugged into the circuit board 40 in a pluggable manner, which can improve the disassembly and assembly efficiency of the wiring harness 73 and the circuit board 40, and dismounting and maintenance are facilitated.

In an embodiment, the electrochemical apparatus 100 further includes a second insulation member 82. The second insulation member 82 is disposed in the first space 17 and located between the first insulation member 81 and the adapter plate 30. The second insulation member 82 is connected to a side of the adapter plate 30 facing away from the battery cell shell 251. In the third direction Z, a projection of the second insulation member 82 overlaps projections of the plurality of conductive members 34, and the projection of the second insulation member 82 overlaps projections of the plurality of conductive plates 252. The second insulation member 82 can protect the plurality of conductive plates 252 to reduce a risk of damage to the conductive plates 252.

In an embodiment, the second insulation member 82 is provided with a fifth through hole 821 and a sixth through hole 822 running therethrough. Both the fifth through hole 821 and the sixth through hole 822 run through the second insulation member 82 in the third direction Z. A portion of the first terminal 71 passes through the fifth through hole 821, and a portion of the second terminal 72 passes through the sixth through hole 822, which can improve the stability of the second insulation member 82 being connected to the substrate 31.

In an embodiment, the second insulation member 82 is provided with a seventh through hole 823 running therethrough. A portion of the wiring harness 73 passes through the seventh through hole 823, which can improve the stability of the second insulation member 82 being connected to the substrate 31.

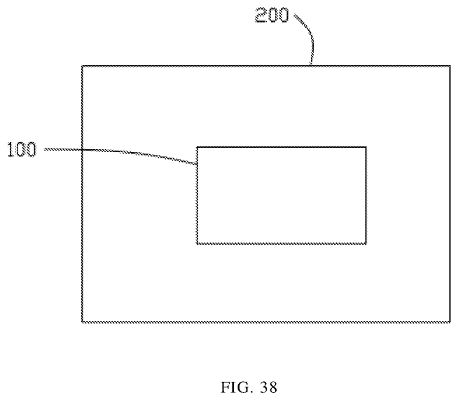

As shown in FIG. 38, an implementation of this application further provides an electrical device 200. The electrical device 200 includes the electrochemical apparatus 100 according to any one of the foregoing embodiments, and the electrochemical apparatus 100 may supply power to the electrical device 200.

In an embodiment, the electrical device 200 includes, but is not limited to, any one of an unmanned aerial vehicle, a two-wheeled electric vehicle, an electric tool, a vacuum cleaner, and a robot.

The electrical device 200 of this application is supplied with power by the electrochemical apparatus 100. According to the electrochemical apparatus 100, the first conductive plate 213, the second conductive plate 222 and the first conductive member 32 are mutually connected well, so that the electrochemical apparatus 100 has a relatively low failure rate, which is conducive to reducing the impact of the electrochemical apparatus 100 on the electrical device 200 due to a failure.

In addition, other changes may be made by persons skilled in the art within the spirit of the present application, and certainly, these changes made in accordance with the spirit of this application shall be included in the scope disclosed in the present application.

1. An electrochemical apparatus, comprising:
a first battery cell, comprising a first conductive plate;
a second battery cell, the second battery cell and the first battery cell being stacked in a first direction, and the second battery cell comprising a second conductive plate; and
a first conductive member; the first conductive plate and the second conductive plate being stacked on the first conductive member, and the first conductive plate and the second conductive plate being connected to the first conductive member through welding; wherein
a mutually connected portion of the first conductive plate and the second conductive plate comprises a first region and a second region, the first conductive plate and the second conductive plate are welded to the first conductive member in the first region, the first conductive plate and the second conductive plate are connected in the second region through welding, and the second region is not connected to the first conductive member through welding.

2. The electrochemical apparatus according to claim 1, wherein,
a length of the first region in a second direction is greater than a length of the first region in the first direction;
a length of the second region in the second direction is greater than a length of the second region in the first direction; and
the second direction is perpendicular to the first direction.

3. The electrochemical apparatus according to claim 1, wherein, in a second direction perpendicular to the first direction, a length of the first region is a first length, a length of the second region is a second length, and the first length is not equal to the second length.

4. The electrochemical apparatus according to claim 3, wherein, the first length is less than the second length.

5. The electrochemical apparatus according to claim 3, wherein, the first length is greater than the second length.

6. The electrochemical apparatus according to claim 1, wherein, in a third direction perpendicular to the first direction, a projection of the first region at least partially overlaps a projection of the first conductive member, and a projection of the second region is separated from the projection of the first conductive member.

7. The electrochemical apparatus according to claim 1, wherein, in a third direction perpendicular to the first direction, a projection of the first region at least partially overlaps a projection of the first conductive member, and a projection of the second region at least partially overlaps the projection of the first conductive member.

8. The electrochemical apparatus according to claim 1, wherein,
the first battery cell comprises a first shell;
the second battery cell comprises a second shell; the second shell and the first shell are stacked in the first direction; and
in a third direction perpendicular to the first direction, the first conductive member is provided with a first side and a second side opposite to each other; the first shell and the second shell are located on the first side of the first conductive member, and the first region and the second region are located on the second side of the first conductive member.

9. The electrochemical apparatus according to claim 8, further comprising a substrate, the first conductive member is disposed on the substrate;
in the third direction, the substrate is provided with a third side and a fourth side opposite to each other, the first shell and the second shell are located on the third side of the substrate, and the first region and the second region are located on the fourth side of the substrate; and
in the third direction, the first conductive member is at least partially exposed to the fourth side of the substrate.

10. The electrochemical apparatus according to claim 3, wherein,
in the second direction, a length of the first conductive plate is a third length, and a sum of the first length and the second length is less than the third length; and
in the second direction, a length of the second conductive plate is a fourth length, and the sum of the first length and the second length is less than the fourth length.

11. The electrochemical apparatus according to claim 3, wherein, in the second direction, a distance between the first region and the second region is a first distance, and the first distance is greater than 0 and less than or equal to 2 mm.

12. The electrochemical apparatus according to claim 1, wherein, in the first direction, a length of the first region is a first dimension, a length of the second region is a second dimension, a length of the first conductive member is a third dimension, and both the first dimension and the second dimension are less than the third dimension.

13. The electrochemical apparatus according to claim 12, wherein, the first dimension is not equal to the second dimension.

14. The electrochemical apparatus according to claim 1, further comprising
a third battery cell, comprising a third conductive plate;
a fourth battery cell, the third battery cell and the fourth battery cell being stacked in the first direction, and the fourth battery cell comprising a fourth conductive plate; and
a second conductive member, the third conductive plate and the fourth conductive plate being stacked on the second conductive member, and the third conductive plate and the fourth conductive plate being connected to the second conductive member through welding, wherein
a mutually connected portion of the third conductive plate and the fourth conductive plate comprises a third region and a fourth region, the third conductive plate and the fourth conductive plate are welded to the second conductive member in the third region, and the third conductive plate and the fourth conductive plate are connected in the fourth region through welding.

15. The electrochemical apparatus according to claim 14, wherein, the fourth region is not connected to the second conductive member through welding.

16. The electrochemical apparatus according to claim 14, wherein, the fourth region is welded to the second conductive member.

17. The electrochemical apparatus according to claim 14, wherein, in a second direction perpendicular to the first direction, a length of the third region is a sixth length, a length of the fourth region is a seventh length, and the sixth length is not equal to the seventh length.

18. The electrochemical apparatus according to claim 14, wherein, in the first direction, a projection of the first region partially overlaps a projection of the third region, and a projection of the second region partially overlaps a projection of the fourth region.

19. The electrochemical apparatus according to claim 14, wherein,
in the first direction, a projection of the third conductive plate is separated from a projection of the first conductive plate and separated from a projection of the second conductive plate, and a projection of the fourth conductive plate is separated from the projection of the first conductive plate and separated from the projection of the second conductive plate.

20. An electrical device, comprising the electrochemical apparatus according to claim 1.
